(19) United States
(12) Patent Application Publication
(10) Pub. No.: US 2023/0055618 A1
(43) Pub. Date: Feb. 23, 2023

(54) Systems and Methods for Management of Token Interactions

(71) Applicant: Artema Labs, Inc, Los Angeles, CA (US)

(72) Inventors: Bjorn Markus Jakobsson, Portola Valley, CA (US); Stephen C. Gerber, Austin, TX (US)

(73) Assignee: Artema Labs, Inc, Los Angeles, CA (US)

(21) Appl. No.: 17/821,444

(22) Filed: Aug. 22, 2022

Related U.S. Application Data
(60) Provisional application No. 63/322,265, filed on Mar. 22, 2022.
(60) Provisional application No. 63/280,184, filed on Nov. 17, 2021.
(60) Provisional application No. 63/256,597, filed on Oct. 17, 2021.
(60) Provisional application No. 63/243,270, filed on Sep. 13, 2021.
(60) Provisional application No. 63/235,682, filed on Aug. 21, 2021.

(51) Int. Cl. G06Q 20/36; H04L 9/32; H04L 9/30; H04L 9/08; H04L 9/06; H04L 9/00; G06F 3/04817

(52) U.S. Cl. CPC G06Q 20/363; G06Q 20/3674; H04L 9/3213; H04L 9/3013; H04L 9/0825; H04L 9/0618; H04L 9/50; G06F 3/04817; G06Q 2220/00

(57) ABSTRACT

Systems and techniques to report token-related events within an NFT platform are illustrated. One embodiment includes a method for facilitating use of digital wallets including initiating, in a digital wallet, a view disclosing characterizations of content on a user interface; generating, within the view, one or more partitions; wherein each partition corresponds to a content classification and a set of access rights; and moving one or more icons into a first partition of the one or more partitions; wherein each icon corresponds to a token.

### CROSS-REFERENCE TO RELATED APPLICATIONS

The current application claims the benefit of and priority under 35 U.S.C. § 119(e) to U.S. Provisional Patent Application No. 63/235,682 titled “Transaction Reporting Infrastructure” filed Aug. 21, 2021, U.S. Provisional Patent Application No. 63/243,270 titled “Token Reporting Structure” filed Sep. 13, 2021, U.S. Provisional Patent Application No. 63/256,597 titled “Token Surveys and Privacy Control Techniques” filed Oct. 17, 2021, U.S. Provisional Patent Application No. 63/280,184 titled “Wallet User Interface for Management of Interaction” filed Nov. 17, 2021, U.S. Provisional Patent Application No. 63/322,265 titled “Escrowed Wallet and Transaction Tracking Technology” filed Mar. 22, 2022, the disclosures of which are hereby incorporated by reference in their entireties for all purposes.

### FIELD OF THE INVENTION

The present invention generally relates to systems and methods directed to reporting activity surrounding non-fungible token transactions within media platforms.

### BACKGROUND

In applications to online commerce, there are currently significant inefficiencies related to the management of information and the automatic generation of and management of interlinked digital representations of state. This can affect information including identity information, ownership, access and usage rights, and predicates about people and organizations. The application of digital structures, non-fungible tokens (NFTs) in particular, to memorializing and managing credential information can address these shortcomings. One of the most significant applications of these structures is naturally reporting transactions.

Using token configurations of the forms disclosed herein may therefore enable the creation of computational structures directed towards reliability, transparency, and functionality. The integration of machine learning technologies and artificial intelligence, as disclosed herein, for the management and interpretation of such NFTs further expands on the computational capabilities that can be achieved.

### SUMMARY OF THE INVENTION

Systems and techniques to report NFT-directed events within an NFT platform are illustrated. One embodiment includes a visual user interface for digital wallets. The visual user interface includes one or more views disclosing characterizations of content, wherein each view comprises. The visual user interface includes one or more icons, wherein each icon corresponds to a token wherein selecting an icon renders the corresponding token. The visual user interface includes one or more partitions, wherein each partition corresponds to a content classification and a set of access rights; wherein hovering over a partition expands a textual explanation of at least one of the content classification and the set of access rights corresponding to the partition; and wherein moving an icon into a partition can attribute the content classification and set of access rights corresponding to the partition to the token corresponding to the icon an index listing each view of the one or more views.

In a further embodiment, the content classification of at least one partition is selected from the group consisting of tokens that can be observed by, be requested by, be purchased by, be borrowed by, and have related data accessed by third party entities.

In a further embodiment, overlapping partitions contain tokens that fall into multiple content classifications.

In another embodiment, a partition expands in response to user actions associated with the content classification of the partition.

In another embodiment, partitions take a form of at least one of icons and folders within a view.

In still another embodiment, a partition has one or more sub-partitions.

In still another embodiment, the one or more partitions comprise a collection that is made up of a plurality of tokens and is represented by a collection icon.

In a further embodiment, selecting a collection icon expands a visualization depicting the plurality of tokens represented by the collection icon.

In another embodiment, upon detecting an attempt to move an icon into a partition, the visual user interface asks for user confirmation to move the icon.

In still another embodiment, at least one token is selected from the group consisting of a non-fungible token and a sum of cryptocurrency.

One embodiment includes a method of reporting transactions. The method, for each source of a plurality of sources, detects an occurrence of a transaction involving the source collecting data corresponding to the transaction from the source, filters information from the data based on preferences of one or more pre-determined data consumers, and applies transaction classifications to the filtered information. The method generates a plurality of logs based on the filtered information from the plurality of sources, wherein each log is associated with a transaction classification. The method generates estimates of one or more quantities based on the plurality of logs; wherein at least one quantity concerns transaction volume transmitting the plurality of logs to the one or more pre-determined data consumers.

In another embodiment, a quantity of the one or more quantities concerns an estimate of accuracy based on the plurality of logs, and wherein the estimate of accuracy is selected from the group consisting of a confidence interval, a variance, and a risk score.

In another embodiment, at least one of the one or more quantities is selected from the group consisting of estimates of transaction volume, estimates of consumer preference, and indices reflecting a weight of each log.

In still another embodiment, at least one of the plurality of sources is a digital wallet and at least one transaction concerns a token.

In yet another embodiment, the method further includes transmitting the plurality of logs to a fraud detection entity.

In still another embodiment, at least one of the plurality of sources is selected from the group consisting of bank account, credit card account, money market account, debit card account, and cell phone payment application.

In another embodiment, detecting the occurrence of transactions is performed through a cumulative analysis of the plurality of sources at one time.

In still another embodiment, data collected from at least one source is anonymized.

In another embodiment, the method includes receiving compensation from the one or more pre-determined data consumers.

In yet another embodiment, at least one transaction classification is selected from the group consisting of product type, product brand, transaction location, buyer demographic, and seller demographic.

One embodiment includes a non-transitory computer-readable medium storing instructions that, when executed by a processor, are configured to cause the processor to perform operations for reporting transactions. The non-transitory machine-readable medium, for each source of a plurality of sources, detects an occurrence of a transaction involving the source collecting data corresponding to the transaction from the source, filters information from the data based on preferences of one or more pre-determined data consumers, and applies transaction classifications to the filtered information. The non-transitory machine-readable medium generates a plurality of logs based on the filtered information from the plurality of sources, wherein each log is associated with a transaction classification. The non-transitory machine-readable medium generates estimates of one or more quantities based on the plurality of logs; wherein at least one quantity concerns transaction volume transmitting the plurality of logs to the one or more pre-determined data consumers.

In another embodiment, a quantity of the one or more quantities concerns an estimate of accuracy based on the plurality of logs, and wherein the estimate of accuracy is selected from the group consisting of a confidence interval, a variance, and a risk score.

In another embodiment, at least one of the one or more quantities is selected from the group consisting of estimates of transaction volume, estimates of consumer preference, and indices reflecting a weight of each log.

In still another embodiment, at least one of the plurality of sources is a digital wallet and at least one transaction concerns a token.

In yet another embodiment, the instructions further include transmitting the plurality of logs to a fraud detection entity.

In still another embodiment, at least one of the plurality of sources is selected from the group consisting of bank accounts, credit card accounts, money market accounts, debit card accounts, and cell phone payment applications.

In another embodiment, detecting the occurrence of transactions is performed through a cumulative analysis of the plurality of sources at one time.

In still another embodiment, data collected from at least one source is anonymized.

In another embodiment, the non-transitory machine-readable medium includes receiving compensation from the one or more pre-determined data consumers.

In yet another embodiment, at least one transaction classification is selected from the group consisting of product type, product brand, transaction location, buyer demographic, and seller demographic.

One embodiment includes a system for reporting token-related events. The system includes a database listing addresses for potential recipients. The system includes a transmitter configured to detect an event concerning a token wherein the token includes one or more policies. The system includes an executable component configured to detect occurrence of an event, wherein the event meets terms of at least one policy; generate a report to a reporting intermediary when the event is detected, wherein the report includes data corresponding to the event; and addresses corresponding to at least one potential recipient; and transmit the report to the reporting intermediary. The reporting intermediary is configured to assess the report; parse the database for an address of the at least one potential recipient, and forward the report to the address of the at least one potential recipient.

In another embodiment, the reporting intermediary is at least one of an address resolution entity and a service provider.

In another embodiment, the addresses of potential recipients include domain names.

In yet another embodiment, events are selected from the group consisting of an ownership transfer of the token, a rendering of the token, a check-out of the token, a purchase request associated with the token, and a social media like of the token.

In still another embodiment the reporting intermediary is further configured to generate aggregated reports incorporating data from a plurality of reports, wherein the aggregated reports include statistics summarizing corresponding events of the plurality of reports; and transmit the aggregated reports to the address of the at least one potential recipient.

In a further embodiment, the statistics are each selected from the group consisting of estimates of transaction volume, estimates of consumer preference, and demographics of consumers.

In still yet another embodiment, the transmitter anonymizes the report prior to transmitting the report to the reporting intermediary.

In another embodiment, the token is an NFT.

In still another embodiment, the database is stored on a blockchain.

One embodiment includes a machine-readable medium containing bytecode stored within an immutable ledger. The bytecode encodes an event reporting token. The event reporting token includes one or more policies. The event reporting token includes an executable component configured to detect the occurrence of an event, wherein the event meets terms of at least one policy. The event reporting token includes a transmitter configured to generate a report to a reporting intermediary when the event is detected and the token is rendered, wherein the report includes data corresponding to the event; and addresses corresponding to at least one potential recipient; and transmit the report to the reporting intermediary.

One embodiment includes a method directed to tracking digital wallet transactions including generating an anchor token; associating the anchor token with one or more digital wallets; deriving a reference corresponding to the anchor token; encrypting the reference to produce a ciphertext; wherein the ciphertext is encrypted using a public key associated with a designated entity.

In a further embodiment, the anchor token further includes an identifier unique to an owner of at least one digital wallet that is selected from the group consisting of a name, a pseudonym, date of birth, social security number, contact information, a jurisdiction the owner belongs to, and a usage profile of the owner's.

In another embodiment, the reference includes at least one of an indicator pointing to a database entry identifying an owner of at least one digital wallet; and an identifier token disclosing personal information about the owner.

In another embodiment, the reference further includes information for unlocking at least one digital wallet that is selected from the group consisting of a biometric template of an owner of at least one digital wallet and a salted-and-hashed password.

In yet another embodiment, the reference further includes a record of all transactions performed by at least one digital wallet.

In another embodiment, the reference is encrypted using EIGamal-based encryption.

In another embodiment, usage profiles enable sharing among the one or more digital wallets, wherein sharing includes at least one of preferences, usage history, purchase history, and references to digital wallet contents.

In yet another embodiment, the ciphertext is decrypted by a private key corresponding to the public key associated with the designated entity.

In another embodiment, a private key corresponding to the public key associated with the designated entity is distributively held through a polynomial threshold sharing method including multiple members of the designated entity.

In still another embodiment, a privacy policy determined by an owner of at least one digital wallet governs use of the ciphertext by third party entities.

In another embodiment, a pairing including the public key of at least one digital wallet and the reference are stored in a public database.

One embodiment includes a machine-readable medium containing bytecode stored within an immutable ledger. The bytecode encodes an anchor token including a tracker including a ciphertext; wherein the ciphertext is an encrypted reference that confirms association with at least one digital wallet; and wherein the ciphertext is encrypted using a public key associated with a designated entity.

In a further embodiment, the anchor token further includes an identifier unique to an owner of the at least one digital wallet that is selected from the group consisting of a name, a pseudonym, date of birth, social security number, contact information, a jurisdiction the owner belongs to, and a usage profile of the owner's.

In a further embodiment, usage profiles enable sharing among two or more digital wallets, wherein sharing includes at least one of preferences, usage history, purchase history, and references to contents of the two or more digital wallets.

In another embodiment, the anchor token further includes information for unlocking a digital wallet that is selected from the group consisting of a biometric template of an owner of the digital wallet and a salted-and-hashed password.

In still another embodiment, the anchor token corresponds to multiple digital wallets.

In a further embodiment, a private key, corresponding to the public key associated with the designated entity, is distributively held through a polynomial threshold sharing machine-readable medium including multiple members of the designated entity.

In another embodiment, the tracker is encrypted using EIGamal-based encryption and further includes a record of all transactions performed by the at least one digital wallet.

In another embodiment, the ciphertext is decrypted by a private key corresponding to the public key associated with the designated entity.

In yet another embodiment, a privacy policy determined by an owner of at least one digital wallet governs use of trackers by third party entities.

One embodiment includes a method directed to wallet surveying including activating a trigger configured to initiate a digital wallet survey of one or more compartments of a digital wallet. The trigger is located in a token and the token is located in a first compartment. The method reviews at least one of a digital wallet policy including requirements for digital wallet surveys of the one or more compartments; and a token policy including requirements for digital wallet surveys initiated by the trigger. The method initiates the digital wallet survey. The method produces, through the digital wallet survey, an output including a summarizing report of contents of the first compartment.

In another embodiment, the summarizing report is applied to an action selected from the group consisting of identifying likely needs for information, identifying needs for products, identifying needs for security, configuring the digital wallet; and generating recommendations to an owner of the digital wallet based on various user preferences.

In still another embodiment, results of the digital wallet survey are reported to a third party entity.

In a further embodiment, the results are anonymized to block identifying information of at least one of the digital wallet and an owner of the digital wallet.

In another embodiment, the third party entity is an advertiser.

In still another embodiment, the trigger is activated when the token is rendered.

In yet another embodiment, the token further includes a content element and a certification confirming effectiveness of the trigger.

In a further embodiment, memory is accessed prior to initiating the digital wallet survey in order to determine when any queries have been recently answered.

In yet another embodiment, reviewing at least one of the digital wallet policy and the token policy determines the contents of the output.

In a further embodiment, the output further includes a summarizing report of contents of other compartments of the one or more compartments.

One embodiment, includes a machine-readable medium containing bytecode stored within an immutable ledger. The bytecode encodes a survey token including a content element. The survey token includes a token policy including requirements for digital wallet surveys by the survey token; wherein a digital wallet survey produces a summarizing report of contents of one or more compartments of a digital wallet holding the survey token; and wherein each result in the summarizing report responds to a particular query of the digital wallet survey. The survey token includes; a trigger configured to initiate the digital wallet survey and including a set of instructions for the digital wallet survey. The survey token includes a certification of effectiveness of the trigger.

In a further embodiment, summarizing reports are applied to actions selected from the group consisting of identifying likely needs for information, identifying needs for products, identifying needs for security, configuring the digital wallet; and generating recommendations to an owner of the digital wallet based on various user preferences.

In still another embodiment, results of the digital wallet survey are reported to a third party entity.

In a further embodiment, the results are anonymized to block identifying information of at least one of the digital wallet and an owner of the digital wallet.

In still another embodiment the third party entity is an advertiser.

In yet another embodiment, the trigger of a token is activated when the survey token is rendered.

One embodiment includes a method for facilitating use of digital wallets. The method initiates, in a digital wallet, a view disclosing characterizations of content on a user interface. The method generates, within the view, one or more partitions; wherein each partition corresponds to a content classification and a set of access rights. The method moves one or more icons into a first partition of the one or more partitions; wherein each icon corresponds to a token; wherein selecting on an icon renders the corresponding token; and wherein moving an icon into the first partition can attribute the content classification and set of access rights corresponding to the first partition to the token corresponding to the icon; and adding the view to an index listing identifiers for one or more additional views.

In a further embodiment, the content classification of at least one partition is selected from the group consisting of tokens that can be observed by, be requested by, be purchased by, be borrowed by, and have related data accessed by third party entities.

In another embodiment, a partition takes a form of at least one of a partition icon and a folder within the view.

In another embodiment, a second partition has one or more sub-partitions.

In a further embodiment, a third partition and a fourth partition overlap and create a shared sub-partition; and wherein the shared sub-partition contains one or more tokens that fall under the content classification and the set of access rights of both the third partition and the fourth partition in tandem.

In another embodiment, the method further includes detecting a user action associated with the content classification of a fifth partition; and expanding the fifth partition in the user interface.

In a further embodiment, the method detects an attempt to move an icon into a sixth partition; and asking, through the user interface, for user confirmation for moving the icon.

In yet another embodiment collections that are made up of a plurality of tokens are represented by collection icons.

In another embodiment, selecting a collection icon expands a visualization depicting the plurality of tokens represented by the collection icon.

In another embodiment, at least one token is selected from the group consisting of a non-fungible token and a sum of cryptocurrency.

In still yet another embodiment, the method detects a pointer hovering over a partition. The method expands a textual explanation of at least one of the content classification and the set of access rights corresponding to the partition.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention.

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIGS. 14D-14F depicts views within media wallet applications in accordance with various embodiments of the invention.

FIG. 15 illustrates an NFT ledger entry corresponding to an NFT identifier in accordance with several embodiments of the invention.

FIGS. 16A-16B illustrate an NFT arrangement relationship with corresponding physical content in accordance with some embodiments of the invention.

FIG. 17 illustrates a process for establishing a relationship between an NFT and corresponding physical content in accordance with a number of embodiments of the invention.

FIG. 18 depicts a conceptual diagram of an association between a digital wallet and anchor NFTs in accordance with some embodiments of the invention.

FIGS. 19A-19C conceptually illustrates a reporting and filtering system targeted to NFT transactions in accordance with many embodiments of the invention.

FIG. 20 illustrates a process followed by a reporting and filtering system operating in accordance with various embodiments of the invention.

FIG. 21 depicts a conceptual diagram of an NFT event reporting process in accordance with some embodiments of the invention.

FIG. 22 illustrates a process followed by an address resolution entity in routing reports, in accordance with various embodiments of the invention.

FIG. 23 illustrates a process followed by a service provider in processing event reporting statistics, in accordance with numerous embodiments of the invention.

FIG. 24 illustrates the processing flow for an example survey situation, in accordance with several embodiments of the invention.

FIG. 25 illustrates a media wallet application configuration in accordance with some embodiments of the invention.

FIG. 26 illustrates a token configuration for token surveys, in accordance with a number of embodiments of the invention.

### DETAILED DESCRIPTION

Systems and methods for incorporating reporting functionality into non-fungible token (NFT) platforms, in accordance with various embodiments of the invention, are described herein. Reporting functionality may include, but is not limited to, digital wallet configurations directed to disclosing wallet contents to observers; tracking wallet transactions through particular tokens types; aggregating wallet information to estimate transaction volumes; reporting select events associated with NFTs to third party entities; and communicating surveys of wallet contents to third parties.

NFT platforms in accordance with a number of embodiments of the invention may use particular digital wallet configurations to manage and classify wallet contents for use by wallet owners as well as third parties. Systems and methods in accordance with such embodiments may incorporate user configurations to represent NFTs with NFT icons and NFT collection icons. NFT content may be organized within digital wallet through user interface partitions in order to classify certain NFTs based on a variety of attributes as well as user preferences.

Systems in accordance with various embodiments of the invention may utilize anchor NFTs tied to individual users in order to identify digital wallet owners. Anchor NFTs may be utilized by particular organizations and/or jurisdictions to retrieve data on parties to particular transactions. Records associated with particular anchors may be encrypted in order to preserve the user privacy. Entities including but not limited to governing bodies may implement systems and methods in accordance with some embodiments of the invention to regulate systems surrounding token transactions.

In accordance with a number of embodiments, transactions, consumption, and access surrounding NFTs may be willfully reported to processing entities. Systems and methods in accordance with such embodiments may enable businesses to collect and analyze data associated with token use. Users may willingly agree to share information surrounding their consumption habits in exchange for free, for benefits, and/or for compensation. Alternatively or additionally, in accordance with some embodiments of the invention, particular events associated with NFT use (such as sales) may be filtered and transmitted to a variety of entities.

NFT platforms in accordance with a number of embodiments of the invention may survey the digital wallets and associated devices of individual users. Wallet and device surveys may be applied to a variety of ends including, but not limited to, determining likely responsiveness to certain methods of advertising and assessing the popular demographics for certain categories of tokens.

While various token and wallet configurations are discussed above, reporting functionalities that can be utilized within NFT platforms in accordance with various embodiments of the invention are discussed further below.

### Non-Fungible Token (NFT) Platforms

Turning now to the drawings, systems and methods for implementing blockchain-based Non-Fungible Token (NFT) platforms in accordance with various embodiments of the invention are illustrated. In accordance with several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In accordance with many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In accordance with many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In accordance with many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In accordance with several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

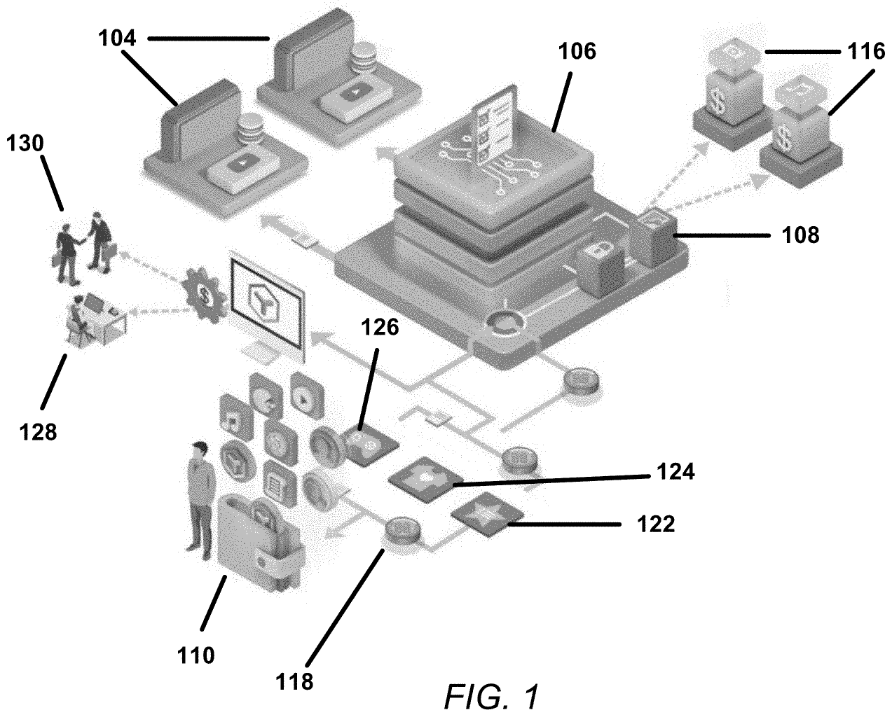

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In accordance with several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In accordance with many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In accordance with many embodiments, the verified users can be content creators that are vetted by an administrator of networks that may be responsible for deploying and maintaining the NFT blockchain. Once the NFTs are minted, users can obtain and conduct transactions with the NFTs. In accordance with several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In accordance with many embodiments, the fungible tokens can be fully converted into fiat currency and/or other cryptocurrency. In accordance with several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In accordance with several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In accordance with many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users 128. In addition, content creators can directly issue NFTs to the media wallets of specific users (e.g. by way of push download or AirDrop). In accordance with many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the users. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When users wish to purchase NFTs using fungible tokens, media wallet applications can request authentication of the NFTs directly based upon the public key of the content creators and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In accordance with several embodiments, the public blockchain is decentralized and universally accessible. Additionally, in a number of embodiments, private/permissioned blockchains are closed systems that are limited to publicly inaccessible transactions. In accordance with many embodiments, the permissioned blockchain can be in the form of distributed ledgers, while the blockchain may alternatively be centralized in a single entity.

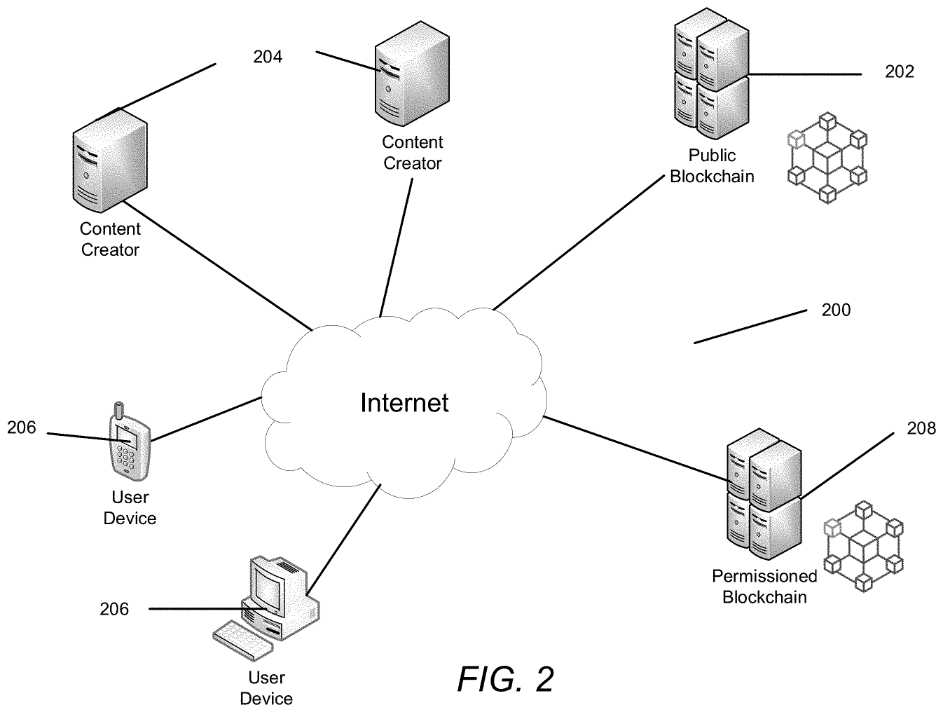

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with users based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In accordance with many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In accordance with many embodiments, NFT transaction data entries in the permissioned blockchain 208 are encrypted using users' public keys so that the NFT transaction data can be accessed by the media wallet application. In this way, users control access to entries in the permissioned blockchain 208 describing the users' NFT transactions. In accordance with several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In accordance with several embodiments, the permissioned blockchain 208 supports access control lists and users can utilize a media wallet application to modify permissions granted by way of the access control list. In accordance with many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In accordance with many embodiments, storage nodes within the permissioned blockchain 208 do not provide content creators with access to entire NFT transaction histories. Instead, the storage nodes simply provide access to encrypted records. In accordance with several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In accordance with several embodiments, the access to the data is determined by computer systems that implement permission-based data access services.

In accordance with many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In accordance with some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

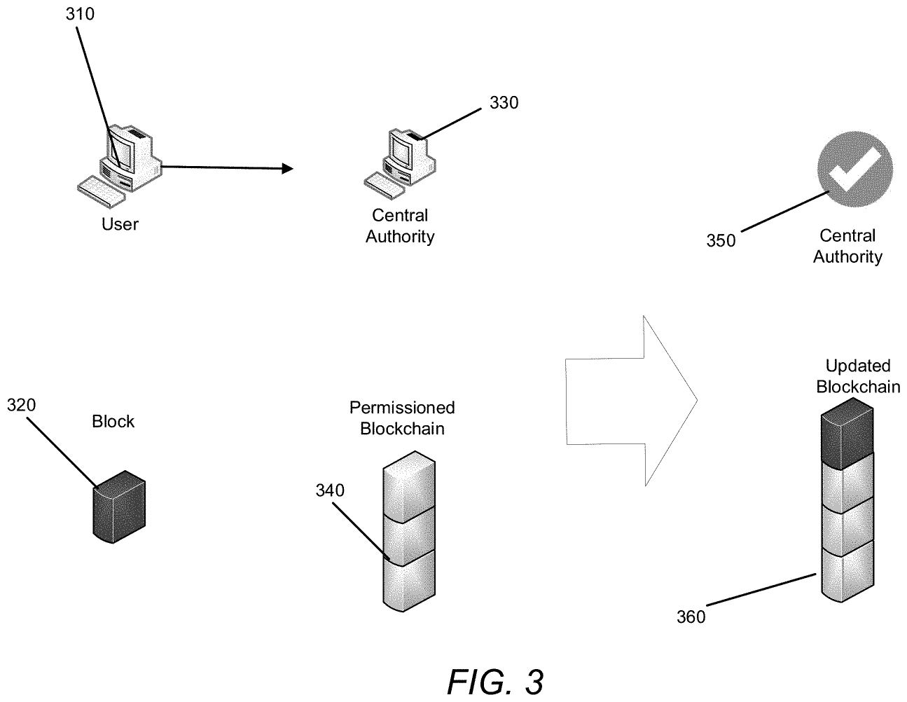

An implementation of permissioned (or private) blockchains in accordance with some embodiments of the invention is illustrated in FIG. 3. Permissioned blockchains 340 can typically function as closed computing systems in which each participant is well defined. In accordance with several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these modes. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

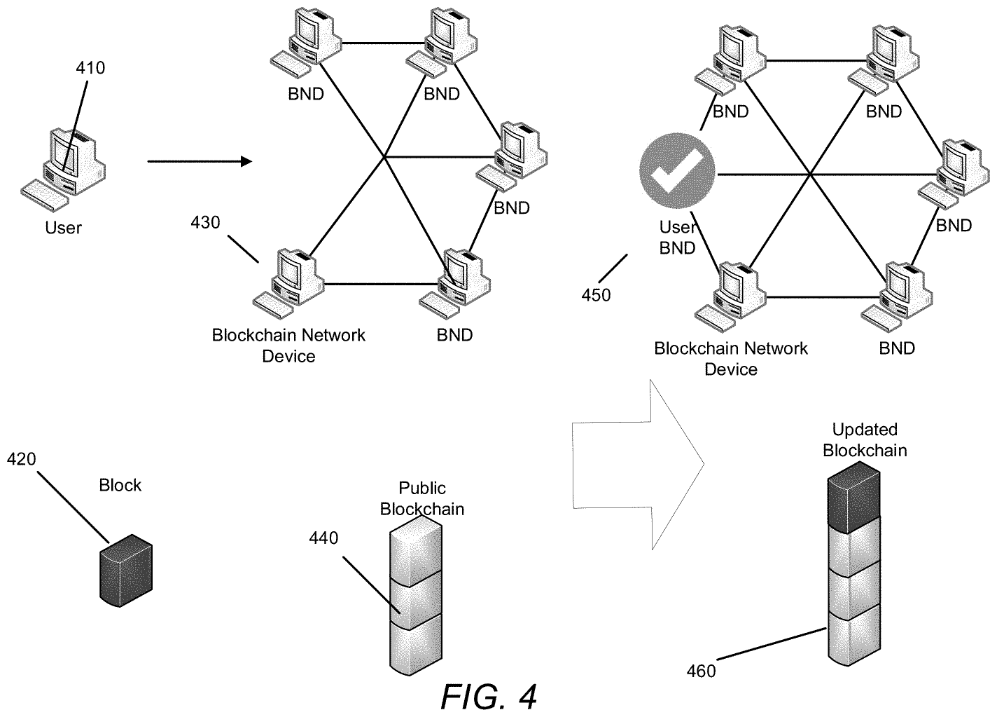

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In accordance with many decentralized blockchains, many blockchain network devices 430, in the decentralized system may have copies of the blockchain, allowing the ability to validate transactions. In accordance with many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the modes to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In accordance with many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In accordance with some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

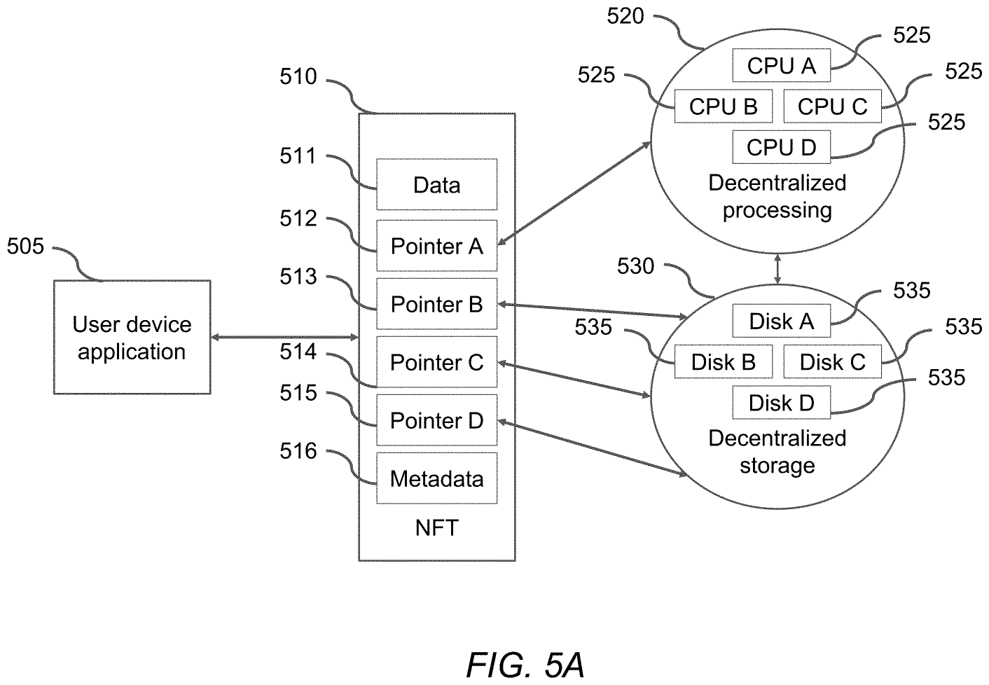

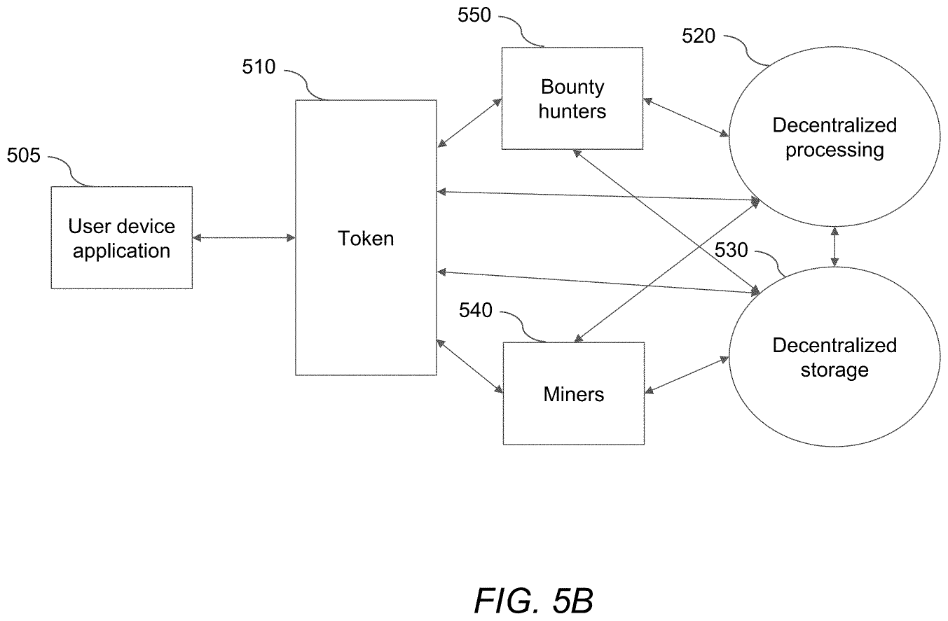

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In accordance with some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In accordance with some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a mode of demonstrating non-trivial allocations of processing power. Proof of Space (PoS) mechanisms may be used as a mode of demonstrating non-trivial allocations of memory or disk space. As a third possible approach, Proof of Stake mechanisms may be used as a mode of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In accordance with several embodiments the network optimization challenge may be selected from any of a number of different challenges appropriate to the requirements of specific applications including graph pebbling. In accordance with some embodiments, graph pebbling may refer to a resource allocation game played on discrete mathematics graphs, ending with a labeled graph disclosing how a player might get at least one pebble to every vertex of the graph.

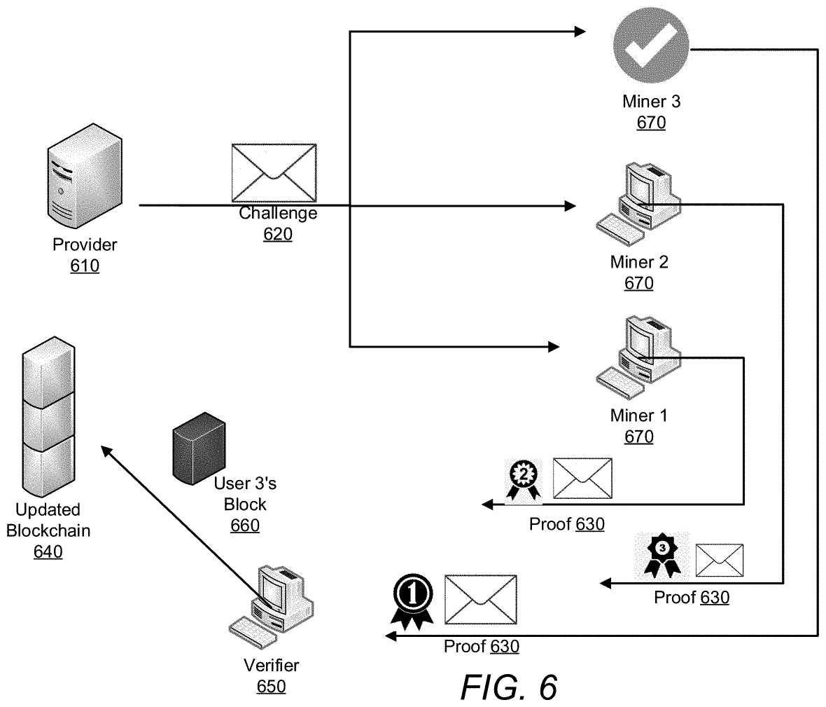

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

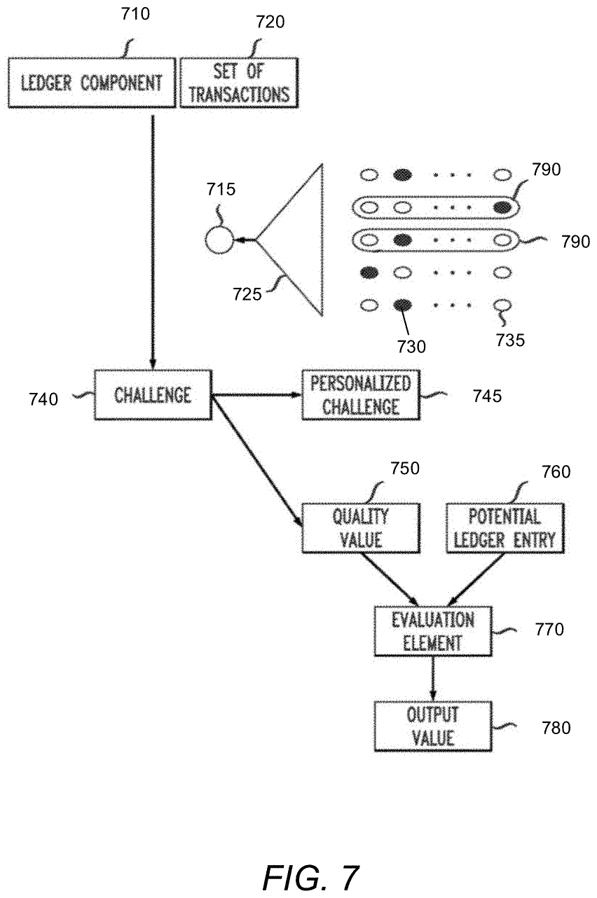

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In accordance with some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In accordance with several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In accordance with some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In accordance with some embodiments, non-proportional relationships may be created by modifying the function used to compute the quality value 750. When the evaluation 770 results in success, then the output value 780 may be used to confirm the suitability of the memory configuration and validate the corresponding transaction.

In accordance with many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In accordance with many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, In accordance with many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In accordance with many embodiments, the hybrid mechanism may incorporate a first and a second consensus mechanism. In accordance with several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

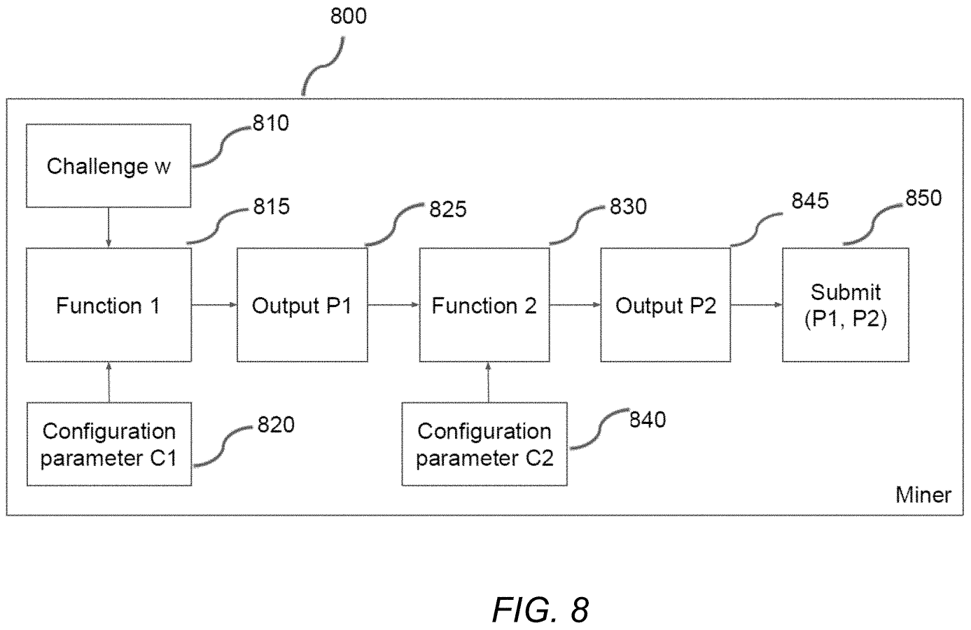

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In accordance with some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone(™) or Intel SGX(™) may provide assurances exist of integrity by virtue of incorporating private/isolated processing environments.

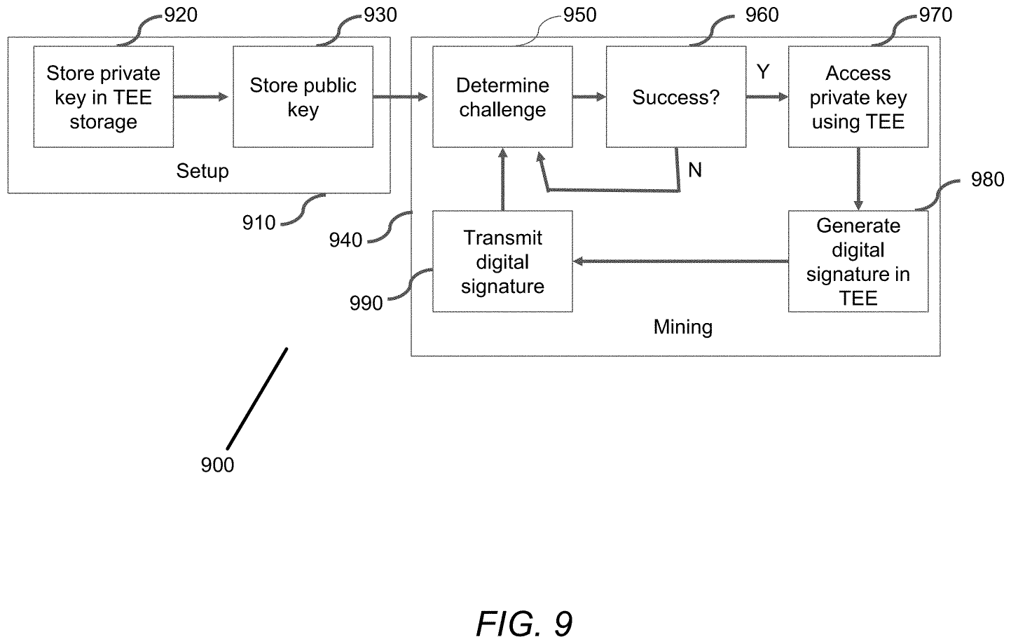

An illustration of sample process 900 undergone by TEE-based consensus mechanisms in accordance with some embodiments of the invention is depicted in FIG. 9. In accordance with some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In accordance with many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In accordance with some embodiments of the invention, the determination of success may result from some pre-set portion of the challenge matching a pre-set portion of the public key, e.g. the last 20 bits of the two values matching. In accordance with several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In accordance with several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In accordance with several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

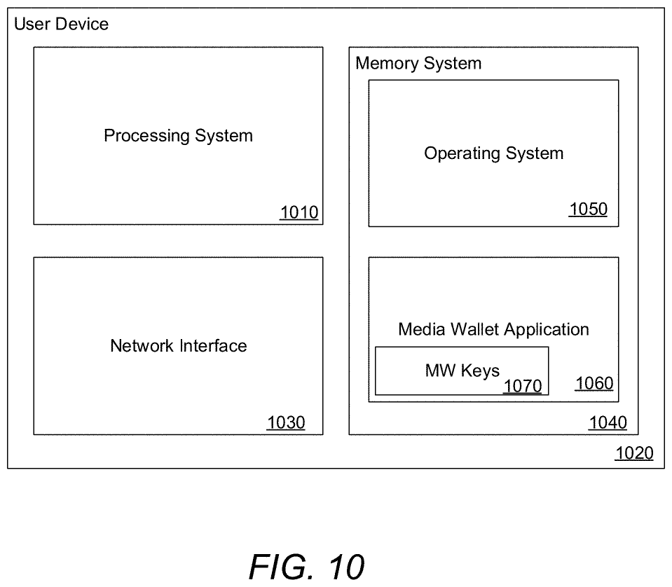

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In accordance with many embodiments, the media wallet application enables the user device to obtain and conduct transactions with respect to NFTs by communicating with an NFT blockchain via the network interface 1030. In accordance with some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

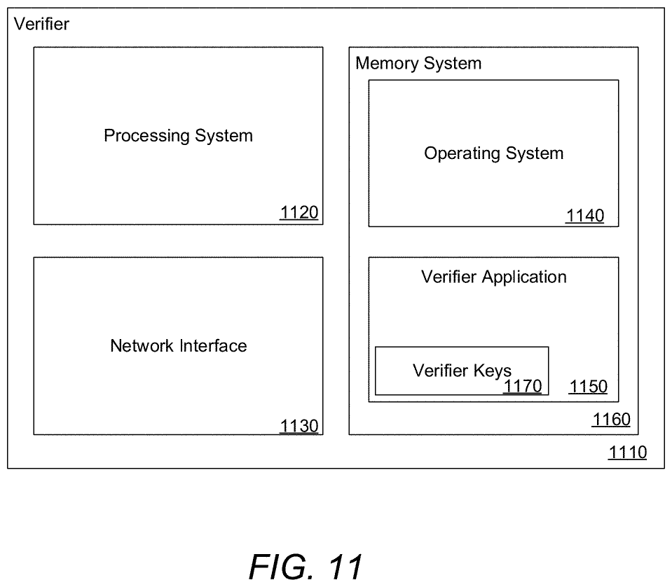

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

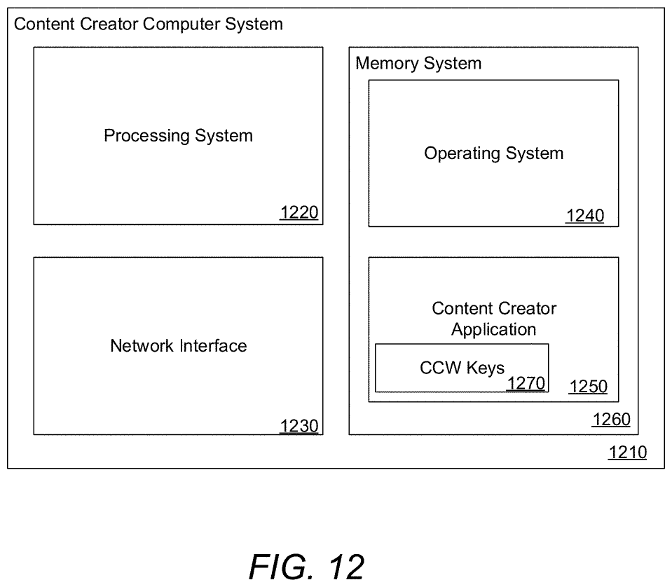

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In accordance with several embodiments, the digital wallet may securely store rich media NFTs and/or other tokens. Additionally, In accordance with some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

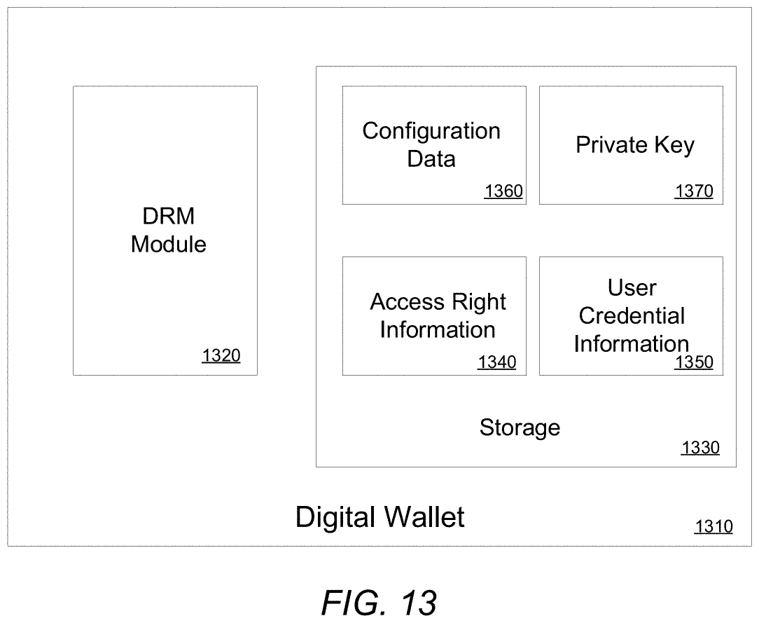

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 In accordance with some embodiments may also use one or more keys to communicate with a DRM server. In accordance with several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

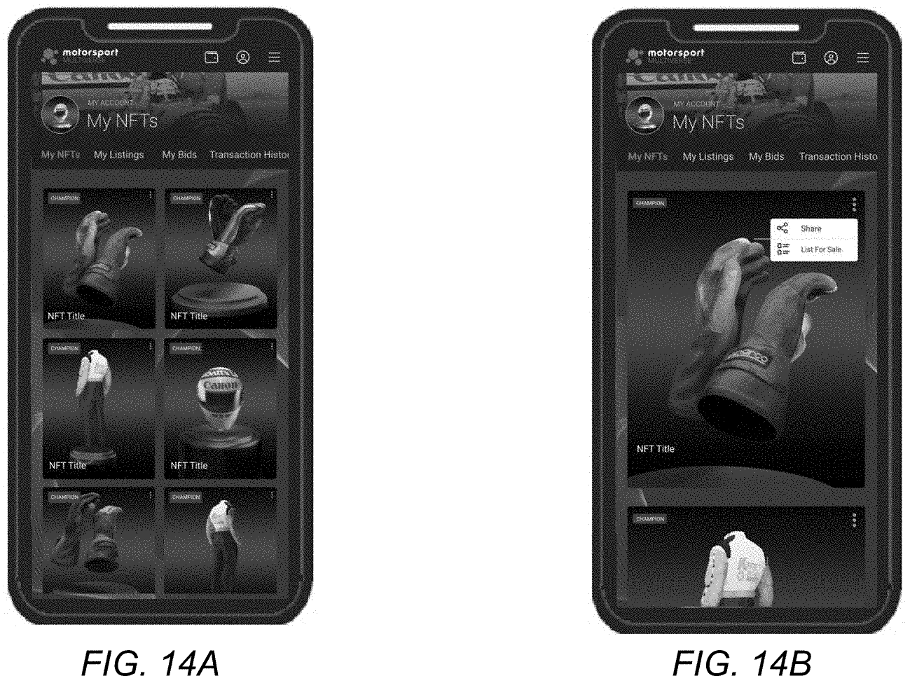

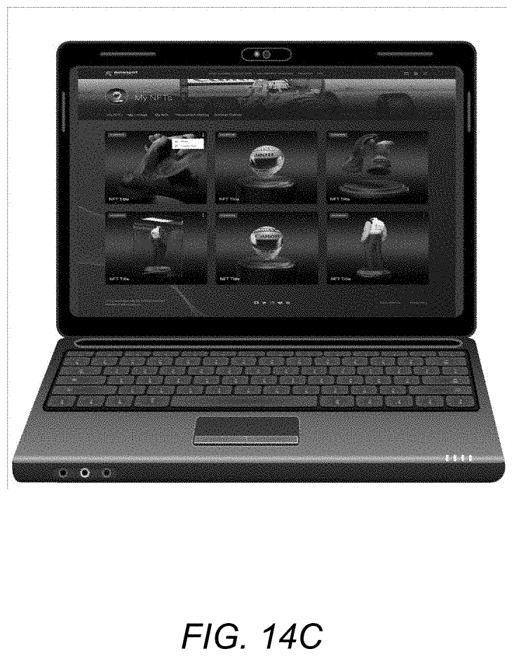

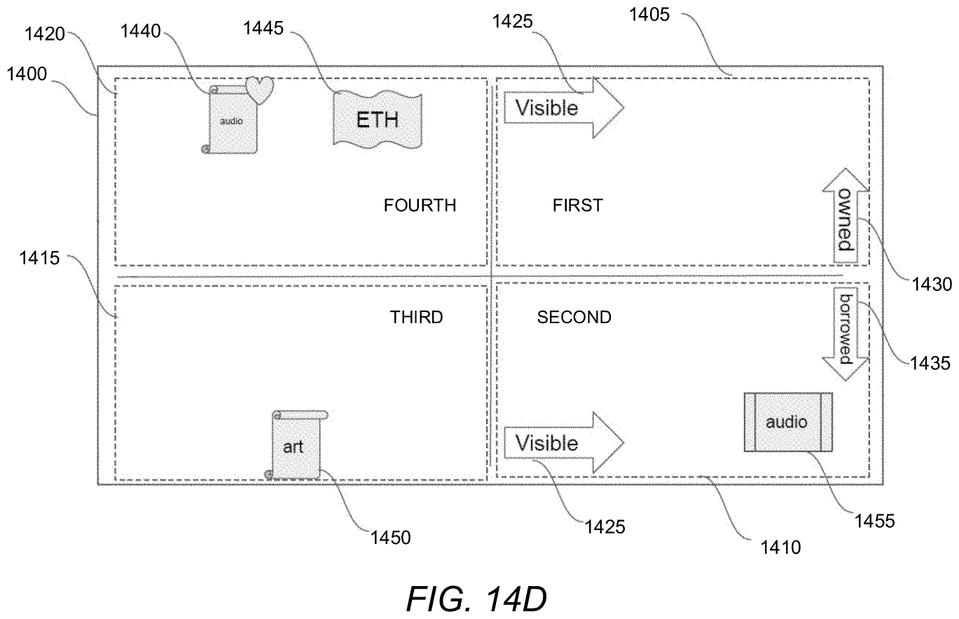

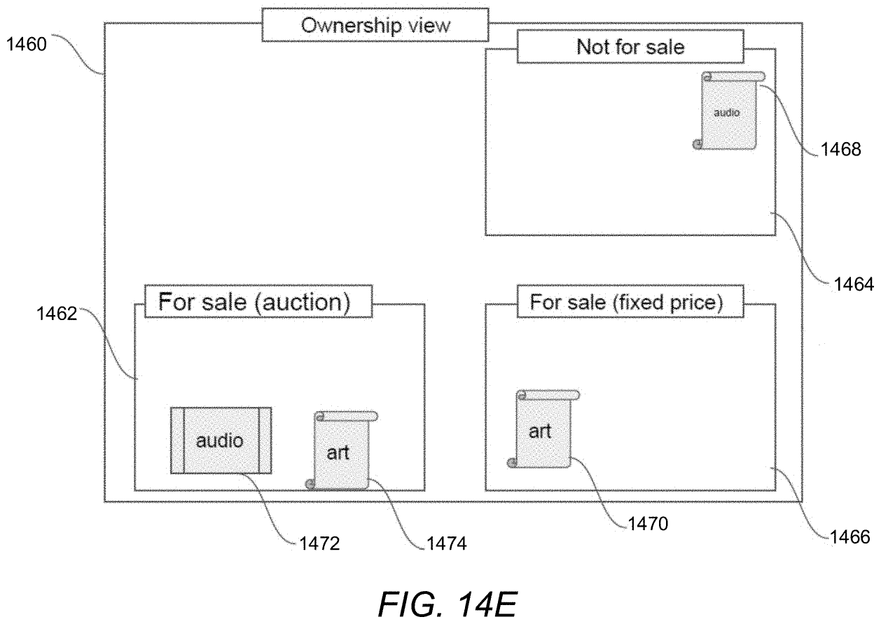

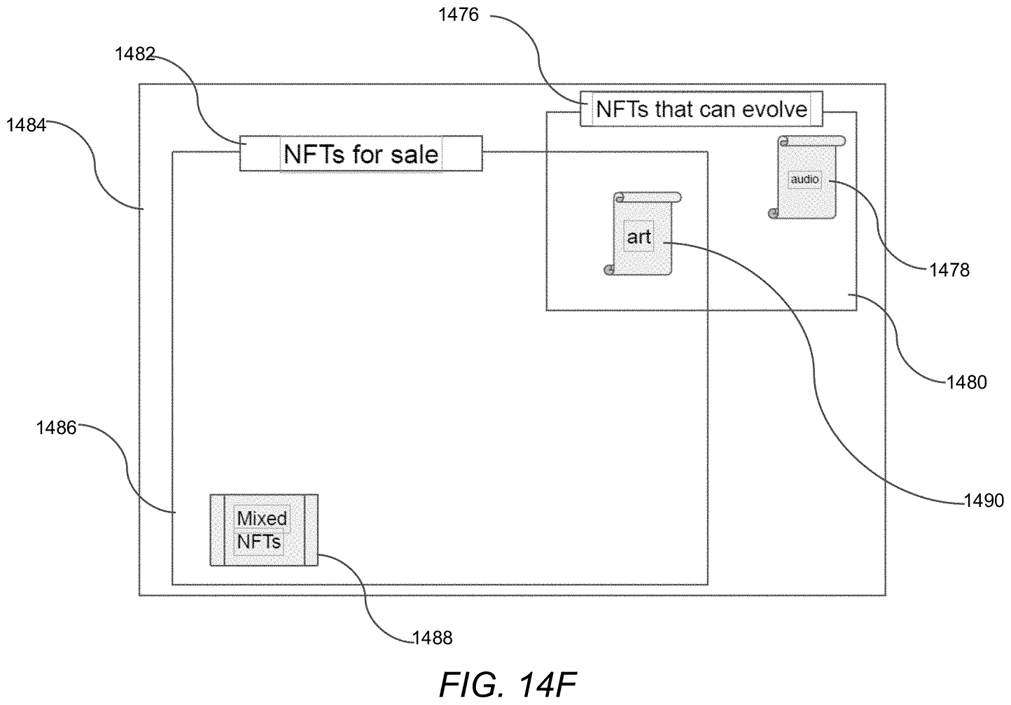

Operation of media wallet applications implemented in accordance with some embodiments of the invention is conceptually illustrated by way of the user interfaces shown in FIGS. 14A-14C. In accordance with many embodiments, media wallet applications can refer to applications that are installed upon user devices such as (but not limited to) mobile phones and tablet computers running the iOS, Android and/or similar operating systems. Launching media wallet applications can provide a number of user interface contexts. In accordance with many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In accordance with several embodiments, a first user interface context is a dashboard (see, FIGS. 14A, 14C) that can include a gallery view of NFTs owned by the user. In accordance with several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In accordance with some embodiments of the invention, a visual partition may in turn be partitioned into sub-partitions. In accordance with some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In accordance with some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In accordance with some embodiments, wallet content may be rendered using two or more views in a simultaneous manner. They may also select items using one view.

By dragging items into collections and/or partitions in differing views, the associated classification and access rights associated with the items may change. An example visual user interface view in accordance with a number of embodiments of the invention is disclosed in FIG. 14D. The visual user interface 1400 is divided into four partitions, namely a first partition 1405, a second partition 1410, a third partition 1415 and a fourth partition 1420. Visibility indicators 1425 may convey the meaning of first partition 1405 and second partition 1410. The visibility indicators 1425 can specifically convey that the contents in certain partitions 1405, 1410 are visible to the outside world. This indication may implicitly display that the third partition 1415 and fourth partition 1420 correspond to partitions that are not visible. Ownership indicators 1430 may convey that content in first partition 1405 and fourth partition 1420 are owned. Indicators may also convey that content in the second partition 1410 and third partition 1415 are unowned, but borrowed.

User interfaces may, when rendering content of partitions, indicate that sub-partitions can be shown as icons. Icons may be double-clicked (or otherwise selected) to be expanded. Elements of sub-partitions may be represented visually when the associated partitions, in which the sub-partitions are located, are viewed. Similarly, collections can be represented by icons and/or by groupings of icons corresponding to the members of the collections. Collections may exist in multiple forms, including but not limited to user-curated collections (“folders”) and machine-generated collections (“clusters”). Some collections may be user-curated in part and machine-generated in part. In a number of embodiments of the invention, systems may automatically configure how content rendering in user interface views can be performed, based on the number of members of a given collection. For example, when the number of elements in a collection exceed a threshold number, then the elements may be represented by clickable icons and/or icons that expand when hovered over. When there is a smaller number than the threshold, icons associated with the individual members may instead be rendered directly in the user interface views.

In accordance with FIG. 14D, audio NFT icons 1440 can represent specific audio NFTs. The audio NFT associated with the icon 1440 part of the fourth partition 1420, may not be visible to the outside world. Funds icons 1445, such as the icon in the fourth partition 1420, can be used to refer to funds. For example, the funds icon 2445 in the fourth partition may refer to funds in the Ethereum (ETH) blockchain. The location of funds icons 1445, can simultaneously indicate that they are owned and not visible (e.g., the fourth partition). An art NFT icon 1450 may have a descriptor indicating that it refers to an art NFT. In FIG. 14D, the art NFT icon's 1450 placement in the third partition 1415 can indicate that the art NFT is borrowed and not visible.

Collection icons can be used to refer to collections of NFTs. Collection icons may include labels referring to the types of NFTs in the collection. For instance, the collection icon 1455 in the second partition 1410 has an “audio” label that additionally reflect that the collection contains audio NFTs. The location of the collection icon 1455 in the second partition 1410 can indicate that the NFTs associated with that collection are borrowed and visible. Observers of wallets associated with visual user interfaces 1400 may be able to tell that a user has borrowed audio NFTs kept in a collection.

Though observers may be able to determine facts associated with NFTs in visible partitions. For example, an observer looking at a visual user interface view in accordance with FIG. 14D, may determine facts associated with the collection icon 1455 in the second partition 1410. In accordance with various embodiments of the invention, possible accessible facts may include, but are not limited to, information on who the owner is, what the price of purchase is (assuming the owner of the NFTs has indicated that they are for sale by placing them in a “for sale” partition), and/or information about the creator of constituent NFTs. Observers may be able to view representations of the NFTs in visible partitions. In relation to visible audio NFTs, this may be in the form of a short clip of audio content.

Users with access rights to make configuration changes, when viewing visual user interfaces on computers, may drag and drop icons to change the access rights for the associated NFTS. For example, a user interacting with the visual user interface represented in FIG. 14D may move the art NFT icon 1450 from the third partition 1415 to the second partition 1410 in order to make the associated NFT visible. Alternatively, when an icon is dragged to the fourth partition 1420, changing a classification from “borrowed” to “owned,” the action that may correspond to a request to obtain ownership (purchase the NFT). In the latter case, systems in accordance with various embodiments may then request information about purchase price to be displayed to the requesting user(s), who may decide whether to perform the purchase or not. When purchase requests made in this fashion are agreed to, NFT icons may be moved to partitions labeled “owned” (e.g., the fourth partition 1420). Otherwise, they icons may be returned to the location from which they were dragged.

In accordance with several embodiments of the invention, partitions may also correspond to content that users are willing to sell. “On sale” content may be placed in sub-partitions based on the manner of preferred sale. The manner of preferred sale may be of a type including, but not limited to an auction, an exchange, and a prespecified (fixed) price. Users can indicate prespecified prices by creating, and placing elements in, partitions associated with the particular prices. For example, partitions may be associated with prices directed to ETH and/or U.S. Dollars. Required reserve prices may be displayed by placing elements in auction sub-partitions that correspond to reserve prices.

An example visual user interface corresponding to a view directed to content sale, in accordance with an embodiment of the invention, is disclosed in FIG. 14E. In the illustrated embodiment, the user interface 1460 has three partitions: a first partition 1462, a second partition 1466, and a third partition 1464. Partitions, such as the first partition 1462 in FIG. 14E, can be specifically directed to an auction. For instance, the elements pointed to in FIG. 14E, by the audio collection 1472 and art NFT 1474 icons, have been placed on auction. One audio collection 1472 icon may correspond to a collection which contains multiple NFTs that are audio NFTs. For auction-directed partitions, the corresponding icons may be clicked on to see popups showing updates on the auctions. Auction updates may have information including, but not limited to, the highest current bid and the time left. The second partition 1466 may include an art NFT icon 1470, corresponding to an art NFT on sale for a fixed price. By clicking on an icon in a fixed price-directed partition, information about the corresponding content may be provided. This information may include, but is not limited to, information on when the NFT was listed, when any offers have been received, and how many views the NFT has received so far. The third partition 1464 here includes an audio NFT icon 1468 that may correspond to an audio NFT not currently being on sale. When the sale of the corresponding element is determined, items that previously were not on sale may be dragged and dropped into a sale-directed partition in order to construct a listing of the item. For example, the audio NFT icon 1468 may be placed in the first partition 1462, to be entered into an auction. Additionally or alternatively, the audio NFT icon 1468 may be dragged and dropped into the second partition 1466, in order to put the audio NFT on sale at a fixed price.

A visual user interface corresponding to one particular view directed to evolving NFTs, in accordance with an embodiment of the invention, is disclosed in FIG. 14F. The embodiment includes a first partition 1480 and second partition 1486. Partitions in accordance with some embodiments of the invention may include indicators stating that they contain content elements that can evolve. As indicated above, evolution of content may correspond to transitions from one representation to another representation. Evolution may be triggered by creators, events associated with creators, external events measured by platforms associated with the content, and/or by specific combinations of event triggers. Evolution is disclosed in co-pending applications U.S. Provisional Patent Application No. 63/275,713, titled “User-Specific Evolution, Spawning and Peeling,” filed Nov. 4, 2021; U.S. Provisional Patent Application No. 63/255,032, titled “Non-Fungible Token Peeling,” filed Oct. 13, 2021; and U.S. Provisional Patent Application No. 63/254,062, titled “Token Evolution with Physical Embodiment,” filed Oct. 13, 2021, the disclosures of which are incorporated by reference in their entireties. The first partition 1480 disclosed in FIG. 14F includes an example evolution indicator 1476. The first partition 1480 also includes an audio NFT 1478 icon and an art NFT 1490 icon, indicating two pieces of content capable of evolving. In FIG. 14F, the second partition 1486 has an indicator 1482 stating that it contains NFTs that are for sale and includes a collection 1488 of mixed NFTs. Example elements belonging to collections 1488 may include, but are not limited to, audio NFTs and art NFTs. As mentioned above, in accordance with several embodiments, partitions of varying types may overlap. In such embodiments, items belonging to multiple partitions may be classified in ways corresponding to all relevant partitions. For example, NFTs 1490 may belong both to the first partition 1480 and the second partition 1486 and be classified both as an NFT that can evolve as well as an item that is for sale.

Other categories of view may correspond to investment aspects of content. There, associated partitions may be made based on attributes including, but not limited to the estimated growth of element values since acquisition, creation, and/or any other particular temporal indicator. A third view may correspond to whether contents are for sale, and if so, how they are to be sold. A fourth may correspond to how the wallet user normally interacts with the elements, and be used to facilitate use.

Relationships between views can be contradictory. For example, it may not be possible for users to indicate that an invisible element is for sale, since no potential buyer would be able to determine the fact that it is for sale. Thus, when systems in accordance with some embodiments determine that two or more classifications are in contradiction with each other, the systems may alert users. Additionally or alternatively, the system may resolve the conflict by making one or more modifications to the classifications.

As indicated above, wallet views may contain multiple partitions, where some partitions may overlap to indicate that elements in their intersection have properties associated with multiple partitions. For example, an NFT that is both for sale and available for rent may be displayed in the intersection between a Venn-diagram-like partition representing “for sale” and another Venn-diagram-like partition representing “for rent”. Each of these partitions may have a different representative coloration, and/or be associated with a text and/or an icon identifying the meaning of the partition. By hovering over icons and/or partitions, user interfaces may provide access to textual explanations of the partition.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14F can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In accordance with some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In accordance with some embodiments, the first social NFT may then be associated with some rights and capabilities, which may be expressed in other NFTs. Additional rights and capabilities may also be directly encoded in a policy of the social security number NFT.

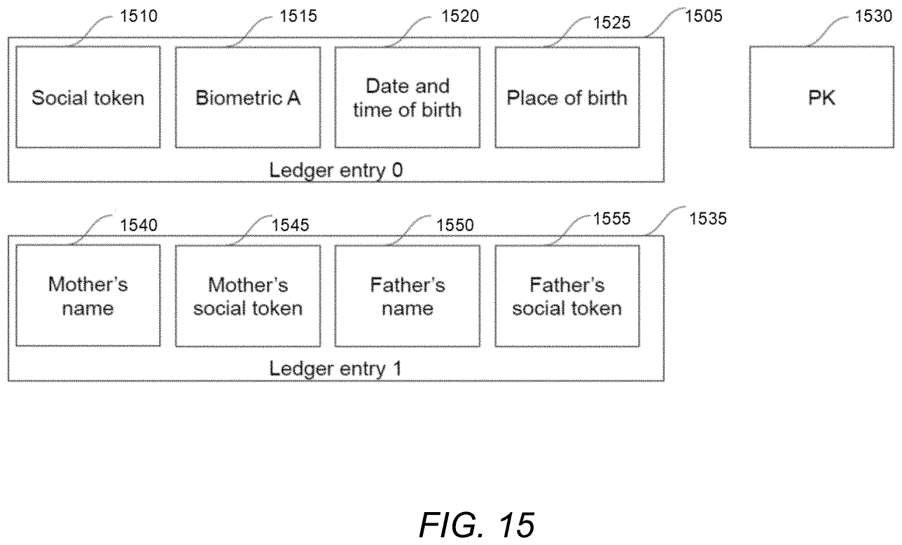

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In accordance with some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In accordance with many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In accordance with some embodiments, an agreement in a machine-readable form may include, but is not limited to, a policy and/or an executable script. In accordance with some embodiments, an agreement in a human-readable form may include, but is not limited to, a text and/or voice-based statement of the promise.

In accordance with some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In accordance with some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In accordance with some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In accordance with some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In accordance with some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In accordance with some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. Anchored NFT may tie to another NFT, which may make it both anchored and relative. An example of such may be called pseudonym NFTs.

Pseudonym NFTs may be a kind of relative NFT acting as a pseudonym identifier associated with a given social NFT. In accordance with some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In accordance with several embodiments, employee NFTs may incorporate their owner's biometrics, such as a face image. In a number of embodiments, employee NFTs may operate as a form of promise NFT. In accordance with some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In accordance with some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In accordance with some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

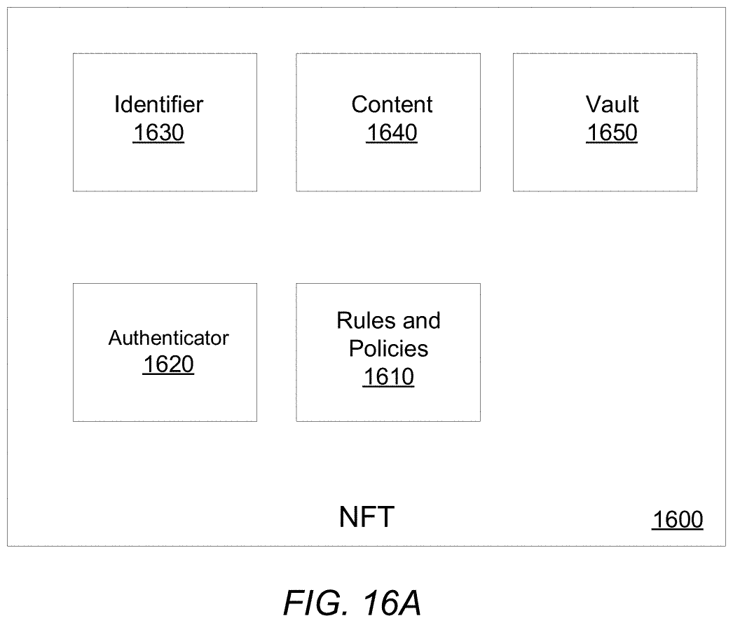

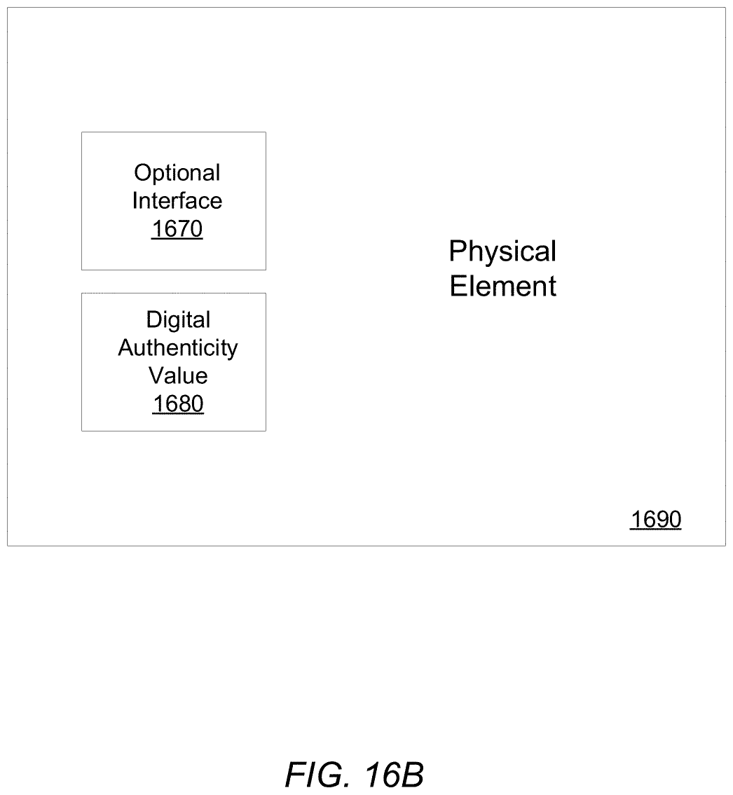

An example NFT which may be associated with specific content in accordance with several embodiments of the invention is illustrated in FIG. 16. In accordance with some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In accordance with some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In accordance with some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In accordance with some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In accordance with some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In accordance with some embodiments, the encoded value may also be represented in an authenticity database. Moreover, the physical interface 1670 may be physically associated with the physical element. One example of such may be a QR tag being glued to or printed on the back of a canvas. In accordance with some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In accordance with some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

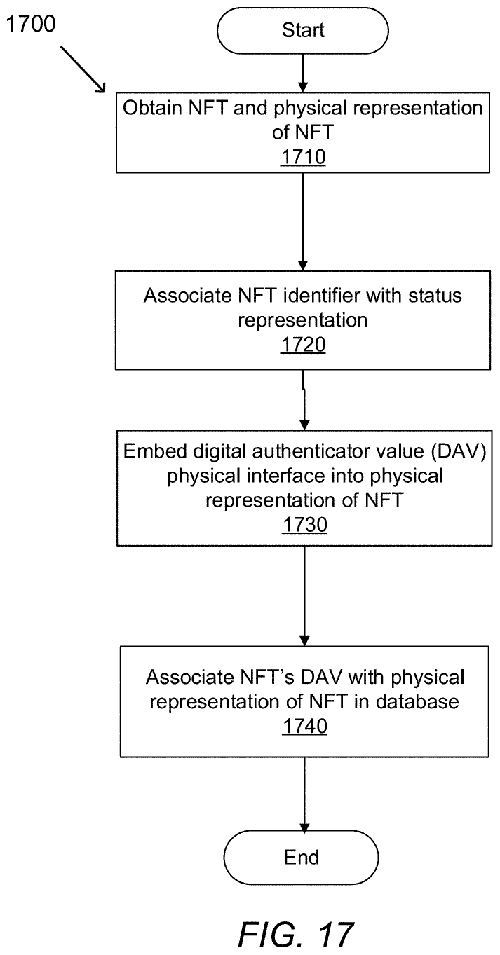

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In accordance with some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

### NFT Platform NFT Reporting

NFT platforms in accordance with many embodiments of the invention may implement systems directed to various reporting capabilities. Reporting capabilities can be applied to tracking wallets, recording transactions, and detailing storage of NFTs and/or fungible tokens.

A. Tracking Transactions

In a number of embodiments of the invention, classifications of anchored NFTs may be used for tracking purposes. In this description, tracking-directed anchored NFTs may be referred to as anchor tokens, anchors, and anchor NFTs. Anchors may be social tokens associated with information such as records of the names, dates of birth, social security numbers, and/or contact information of anchor owners, as disclosed in U.S. patent application Ser. No. 17/808,264, titled “Systems and Methods for Token Creation and Management,” filed Jun. 22, 2022, the disclosure of which is incorporated by reference herein in its entirety. Anchor tokens may be referenced based on modes including but not limited to using unique identifiers associated with the anchor tokens, such as public keys, and/or based on other associated identifiers. In accordance with many embodiments of the invention, implementations using anchor tokens as a form of anchor records can be compatible with the techniques and structures disclosed.

Anchors can be kept in and/or used to identify media wallets. Singular media wallets can correspond to multiple anchors. In accordance with several embodiments, anchor tokens may be used to access records for transactions performed by particular wallets. Anchors may be encrypted to only enable selected entities to access the record associated with them. In accordance with some embodiments, anchors may be social tokens containing information used to unlock particular wallets. Anchors directed to such purposes may incorporate mechanisms including, but not limited to, biometric templates and salted-and-hashed passwords.

Anchors may be explicitly stored in publicly accessible databases, including but not limited to blockchains and private databases (such as databases managed by law enforcement of local jurisdictions). Different jurisdictions may have different approaches to address considerations including, but not limited to, how anchor data (herein also referred to as “anchor records”) may be stored, to whom anchor data is accessible, and what additional data anchors contain.

Anchor tokens in accordance with various embodiments of the invention may identify the jurisdictions that their owners are associated with. Anchor tokens may incorporate unique identifiers associated with the associated jurisdictions. Anchor token jurisdiction identifiers may also correspond to records that are stored in public and/or private databases. Each anchor may correspond to any number of different jurisdictions. People who have two residences may be associated with two or more anchors, for example.

Anchors may correspond to usage profiles of users, where profiles may be associated with one or more wallets. Usage profiles may be used to enable data sharing among wallets that reference the same anchors. Data sharing through usage profiles may be directed to, but is not limited to, user preferences, usage histories and/or references to wallet contents, such as lists of NFTs and cryptocoins.

Records corresponding to anchors may include multiple data elements, where some of these are encrypted and/or some are unencrypted. In accordance with some embodiments, one element may be encrypted using a key associated with a first designated entity, and another may be encrypted using a key associated with a second designated entity. Data elements may correspond to classifications including but not limited to jurisdictions, user preferences, event logs, and/or privacy policies.

Privacy policies corresponding to anchors may be associated with entities including but not limited to users of wallets associated with the anchors, employers of the users, jurisdictions, and/or other authorities. Privacy policies associated with different entities may be in conflict with each other. In such cases, the conflicts may be resolved by a priority associated with the different associated entities. For example, privacy policy components of users may be considered as long as they are not in conflict with those associated with the jurisdiction associated with the user. Based on the privacy policies, designated parties may take tracking actions, upon receiving requests to do so, and/or based on the occurrence of particular events.

Privacy policies may be used to indicate that tracking is performed for events that are considered anomalous according to some standard. For example, systems in accordance with some embodiments of the invention may be set to determine the flow of transactions if an event indicating an account take-over or a wallet theft has taken place. Based on the determined transactions, a security action may be taken. For example, the system may block future transactions. Another user may not wish for such tracking and blocking to occur at all, and may indicate that in the privacy policy. However, if the jurisdiction of this user demands that some tracking is performed under some conditions then tracking may be performed in spite of the user-stated preferences. For example, this tracking may occur if there are suspicions of money laundering or funding of terrorism. In such a case, systems may prioritize jurisdiction-stated policies over user-stated preferences.

We may refer to the selective disclosure of information as tracking. Systems and methods in accordance with many embodiments of the invention may incorporate various forms of tracking. One form of tracking may be to cluster collections of wallets or anchors based on their association with each other. Another form of tracking may be to cluster a collection of wallets or anchors based on them having a specified classification, including but not limited to belonging to a specified jurisdiction; corresponding to high-value investors; and corresponding to a specified behavior (e.g., purchases of music-based NFTs created by a specified musician). Another form of tracking may be a combination of the above methods.

Systems and methods in accordance with some embodiments of the invention may include processing identifying collections of wallets and/or users based on the above specifiers. The result of the processing may include but are not limited to encrypted lists of references to wallet identifiers; an encrypted list of anchor references; some encrypted predicate related to a selection, such as the number of selected wallets; plaintext data; and/or a combination of encrypted and plaintext data. In accordance with many embodiments of the invention, tracking may produce selections of wallets and/or anchors. Relative to the selections, actions including but not limited to security actions, may be taken. One example of a security action may be to restrict access and/or functionality accessible to users that own and/or interact with the relevant wallets. Example interactions include the transfer of ownership of tokens to and from such wallets. Additional actions may include, but are not limited to generating messages to be transmitted to users of selected wallets. Transmitting messages may involve using the wallet addresses as locators. In accordance with several embodiments of the invention, messages may be encrypted, and may be transmitted using mix networks, including but not limited to onion routers.

Example uses of mix networks may involve inputting pairs including the encrypted message(s) and the encrypted wallet address(es); and obtaining as output the differently encrypted message(s) corresponding to the input encrypted message(s) and wallet address(es) in plaintext. In accordance with many embodiments, multiple pairs may be processed simultaneously. Mix network methods such as those disclosed in “Reusable anonymous return channels” by Markus Jakobsson, incorporated by reference in the entirety, can be used to set up two-way interaction between notifying parties (such as the designated entity) and wallets (and/or wallet users). Other relevant techniques were disclosed in and referenced in “Mix and Match: Secure Function Evaluation via Ciphertexts” by Markus Jakobsson and Ari Juels, incorporated by reference in the entirety. Mixing of tuples was disclosed in the 2010 book titled “Towards Trustworthy Elections—New Directions in Electronic Voting”, by Ben Adida, David Chaum, Josh Benaloh, Markus Jakobsson, Miroslaw Kutylowski, Peter Y. A. Ryan, Ronald L. Rivest, incorporated by reference in the entirety.

Systems in accordance with a number of embodiments may enable privacy management in additional ways. One aspect of privacy management may be the concealment of the association between two or more wallets, where the wallets may be owned and/or operated by the same users. Privacy management may also encompass the verification of whether two wallets are associated with each other, e.g., by corresponding to the same owner or user. Privacy management may also involve the clustering of collections of wallets that are associated with each other. Other aspects of privacy management may include, but are not limited to hiding classifications associated with wallets (such as the jurisdiction(s) they correspond to); selectively determining what wallets correspond to given classifications; and taking particular actions for these wallets based on the classifications. Thus, privacy management may include various forms of hiding information and relationships, as well as the selective disclosure of such information. Selective disclosures may be triggered by events such as high-risk indicators. One example of a high-risk indicator may be anomaly-based identification of fraud risks, e.g., associated with a transfer of ownership of assets exceeding a specified value to an entity that has been flagged as potentially being associated with abuse.

For systems in accordance with various embodiments of the invention, a digital wallet may correspond to a public key and a corresponding private key. Public keys in relation to digital wallets may also be referred to as wallet addresses. Private keys in relation to digital wallets may be used to validate transactions including but not limited to transfers of ownership between wallets. In accordance with some embodiments of the invention, transfers of ownership between a first wallet and a second wallet may correspond to a digital signature generated using the private key of the first wallet, being added to a message that comprises the second wallet's public key.

In accordance with a number of embodiments of the invention, records tracking digital wallet transactions (also referred to in this application as “trackers” and “tracking records”) may be generated and associated with wallets and/or wallet transactions. As mentioned elsewhere in this disclosure, digital wallets may include public keys. An example tracking record may include encryption of anchors associated with wallets, where the encryption may be performed using the wallets' public keys. To hide what record the wallet wishes to access, wallets may also use private information retrieval (PIR) to access databases in which transaction records may be stored.

Tracking records may involve encryptions of anchors (herein, “ciphertexts”). In accordance with various embodiments, ciphertexts may be associated with particular entities including but not limited to jurisdictions. For example, a ciphertext may be used to allow entities holding the corresponding private key to derive the associated anchor. In accordance with numerous embodiments, a tracking record may include proofs attesting that a first ciphertext (an encryption of the anchor performed using a wallet's public key) corresponds to a second ciphertext (an encryption of the anchor performed using a jurisdiction's public key).

In accordance with various embodiments of the invention, tracking records may use homomorphic encryption. Homomorphic encryption may include, but is not limited to EIGamal-based encryption, over modular fields and/or elliptic curves. For example, using modular arithmetic over a prime field “p”, wherein g is a generator and “w” is a wallet private key, a wallet public key, “W”, may equal “g\hat{ }w mod p,” wherein mod denotes modular reduction and A represents exponentiation. In such an example, x may be a jurisdiction private key, and the jurisdiction public key, “X” may equal “g\hat{ }x mod p.” In accordance with several embodiments, a wallet's secret key may be derived from the seed phrase of the wallet, using a pseudo-random function generator. In accordance with such embodiments, a plaintext reference to an anchor, “A” may be represented as cyphertext E1=(E1a, E1b)=(g\hat{ }r*A mod p, W\hat{ }r mod p) where*represents modular multiplication and r is a random nonce.

The form the anchor reference takes in instances of homomorphic encryption may also vary. In some instances where modular arithmetic is used for encryption, the anchor reference may be an element in the group generated over the prime field, “p.” In a number of implementations, the anchor reference A may be an integer from 1 to “p−1.” The anchor reference A can also be represented post-encryption as E2=(E2a, E2b)=(g\hat{ }r*A mod p, X\hat{ }r mod p).

When homomorphic encryption is used, the ciphertexts may be decrypted using the corresponding private keys. Specifically ciphertext E1 can be decrypted by the wallet using the wallet's private key (w), and the ciphertext E2 can be decrypted by the jurisdiction, using the jurisdiction's private key (x). A proof that E1 corresponds to E2 (i.e., showing that both ciphertexts encrypt the same anchor reference, A) can be created. In accordance with some embodiments, such a proof may indicate that the discrete log of E1b with respect to the generator W equals the discrete log of E2b with respect to the generator X. Proofs that multiple ciphertexts correspond to the same anchor reference may be created using zero-knowledge proofs and/or using discrete-log based digital signature schemes such as Schnorr signatures and the Digital Signature Algorithm (DSA). Systems in accordance with several embodiments of the invention may utilize different forms of encryption that rely upon cryptographic information derived from anchors.

In accordance with some embodiments, two or more wallets may be associated with the same content, including but not limited to crypto coins and/or non-fungible tokens (NFTs). Different wallets may have different access rights, and may be operated by the same or different users. Different wallets sharing the same content may be appointed different access rights to limit exposure to risk. In some instances, users may choose to have higher access rights in a cold wallet than in a hot wallet. Additionally or alternatively, the capability to transfer ownership of tokens may be an example of a higher access right than the capability to read content associated with a token. A hot wallet may have rights to transfer ownership of a small number of pre-identified tokens but a corresponding cold wallet may have rights to transfer the ownership rights of all tokens associated with the wallet. In accordance with several embodiments, different users may have shared content through different wallets, with different access rights. For instance, one wallet may be associated with a parent and the other with a child and/or one associated with ownership and the other with the capability to render content associated with tokens.

In accordance with some embodiments, wallets may determine anchor references by extracting ciphertexts from tracking records and decrypting the cyphertexts. Anchor references may include the location of anchor records. For example, anchor references may include reference to databases alongside keys to decrypt the databases and access the underlying anchor data. Alternatively or additionally, anchor references may include static identifiers associated with particular users. References from wallets to associated anchors are disclosed in U.S. Provisional Patent Application No. 63/314,424, titled “Crypto Wallet Improvement Technology,” filed Oct. 30, 2021, the disclosure of which is incorporated by reference herein in its entirety. Therein, the anchor data may be stored in cloud storage environments and/or private databases, while including configuration data for wallets. Information corresponding to wallet tracker data may be generated as needed. For example, wallet tracker data may be generated from a seed determining the wallet. Additional wallet trackers can be stored in public databases, and may include encrypted references to the storage locations of the configuration data. In accordance with various embodiments, storage locations may store configuration data including but not limited to data that is private to wallets with access rights thereto; data that may be public (such as for example jurisdiction labels); and encrypted records that can only be decrypted by designated entities. In accordance with several embodiments, the private keys of jurisdictions may be distributively held through modes including but not limited to polynomial threshold sharing.

In accordance with some examples, designated entities may be distributed. For example, a designated entity may include a set number of different participants that share secret information, (such as a private key needed). The secret information may be shared through processes including but not limited to using polynomial secret sharing requiring a threshold number of participants (such as 7 out of 10 participants). Within polynomial secret sharing processes, participants can be added to designated entities by joining and securely sharing a value among all of the other participants, each share being added to the individual shares of the participants. In accordance with some embodiments, the number of participants in designated entities may be reduced. For example, a leaving participant may share their secret share among the remaining participants. Other techniques can be performed, as described in the Proceedings of the 4th ACM Conference on Computer and Communications Security (1997) publication titled “Proactive Public Key and Signature Systems” by Amir Herzberg, Markus Jakobsson, Stanislaw Jarecki, Hugo Krawczyk and Moti Yung, incorporated herein by reference in the entirety. One participant of a designated entity can leave and be replaced by another participant using such techniques. Additionally or alternatively, thresholds can be modified by resharing the secret(s) being shared using other polynomial structures. In accordance with several embodiments, designated entities may correspond to participants that assign a stake, including but not limited to cryptocoins corresponding to a set value, NFTs, and/or a combination thereof. In such cases, designated entities may be managed using staking techniques. Staking-based entities may perform any task requiring the use of the shared secret, which may be used to decrypt, re-encrypt and/or digitally sign, for example. Designated entities may also engage in responsibilities including but not limited to managing privacy, performing selective tracing of transactions, and performing statistical reviews on encrypted data. Additional circumstances in which designated entities may be used are disclosed in co-pending application U.S. Provisional Patent Application No. 63/370,365, titled “Partitioned Address Spaces in a Single Blockchain Wallet,” filed Aug. 3, 2022, the disclosure of which is incorporated by reference herein in its entirety.

Trackers may include references to records that may be stored in a database. Database-stored records may include, but are not limited to biometric templates and additional personal information. In accordance with a number of embodiments, additional personal information may be encrypted using keys included in and/or derived from corresponding anchor references. Biometric templates may be encrypted using keys derived from the seeds of the wallets to which they are associated. In such embodiments, the biometric templates may be protected from non-wallet entities. Additionally or alternatively, both biometric and additional personal information may be accessible by the associated wallets. In accordance with several embodiments, anchor references may constitute pseudonyms of users. Additional personal information may be encrypted using the public keys of third parties. Jurisdictions with access to corresponding private keys may determine pseudonyms, while personal information remains protected. Conversely, the third parties, in collaboration with the jurisdictions, could be able to determine the personal information through the use of the public keys from the third parties.

New wallet instantiations that share seeds with preceding wallet instantiations may perform determinations of associated states as disclosed in U.S. Provisional Patent Application No. 63/314,424, titled “Crypto Wallet Improvement Technology,” filed Oct. 30, 2021, the disclosure of which is incorporated by reference herein in its entirety. Generation of new wallet instantiations may involve reviews of cached record associated with the corresponding anchor. Alternatively or additionally, new wallet instantiations can obtain seeds, determine corresponding anchor records from the seeds, and perform lookups of the cached records through processes including but not limited to private information retrieval and/or traditional database requests using anchor requests to identify cached records. Cached records may include configuration data encrypted using keys generated from the seeds of the wallets; and tracker values in encrypted format that, once decrypted, may be added to the configuration data.

In accordance with several embodiments, tracker values may be publicly stored. For example, the pair (W,T) may be stored in a public database. Here, W may be the wallet public key while T can be the tracker associated with W. The tracker, as disclosed above, may include an encrypted reference, that reference being the anchor reference A, where a designated party associated with a jurisdiction may decrypt at least a portion of the tracker T to obtain the anchor reference. For practical reasons, an indicator identifying the jurisdiction being able to decrypt the tracker T may be stored along with (W,T). In situations where multiple jurisdictions have the capability of tracking, additional trackers and identifiers may be stored.

Transactions performed by wallets, including but not limited to ownership transfers may be logged in blockchain entries. In accordance with various embodiments of the invention, log entries may include references to wallets, including but not limited to records of associated public keys. Using this information, third parties can look up and/or otherwise determine the trackers corresponding to the public keys. Parties with access to private keys may then decrypt at least portions of the trackers, to determine identifying information related to the user(s) associated with the wallets linked to the trackers. By looking up records associated with wallet public keys, users may identify the jurisdictions associated with the records, when recorded along with (W,T). Alternatively or additionally, user-identifying information may be included in the record identified by the anchors derived from the trackers.

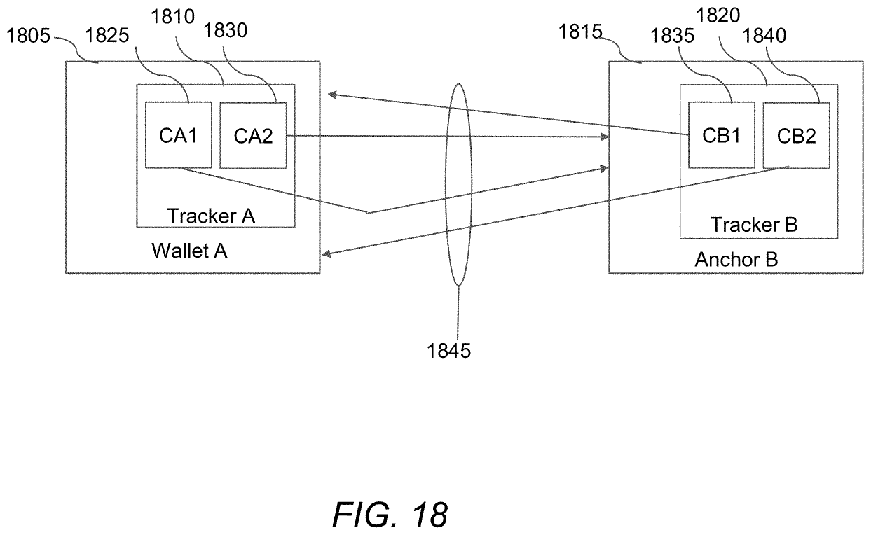

An example of a possible association between wallets and anchors, as facilitated by trackers, is depicted in FIG. 18. Wallet A 1805 is shown with associated tracker 1810, and associated anchor B 1815 with an optional tracker 1820 in accordance with some embodiments of the invention.

A wallet's tracker 1810 may be part of wallet A 1805, as shown. The tracker may also only be associated with wallet A 1805. An optional tracker 1820 may be part of anchor B 1815, as shown. Alternatively or additionally, the optional tracker may simply be associated with anchor B 1815. Tracker values may also be publicly stored. For example, the pair (W,T) may be stored in a public database. Here, W may be the wallet public key and T may be the tracker associated with W. The tracker, as disclosed above, may include an encrypted reference, that reference being the anchor, where a designated party associated with a jurisdiction may decrypt at least a portion of the tracker T to obtain the anchor. An indicator identifying the jurisdiction being able to decrypt the tracker T may be stored along with (W,T). In situations where multiple jurisdictions have the capability of tracking, additional trackers and identifiers may be stored.

Wallets and anchors may both have paired anchor encryptions. Wallet A 1805 reflects this in ciphertexts CA1 1825 and CA2 1830, where ciphertext 1825 corresponds to a reference to anchor B 1815. The reference may be encrypted using a public key associated with wallet A 1805, and where CA2 1830 corresponds to a reference to anchor B 1815. This reference may be encrypted using a public key associated with a designated entity. In accordance with several embodiments, additional ciphertexts may be incorporated as well, corresponding to encryptions of references to anchor B 1815 using other public keys. Anchor B 1815 may also have a tracker 1820 that references wallet A 1805 using ciphertexts. The anchor's tracker 1820 may include ciphertext CB1 1835 and ciphertext CB2 1840. Both ciphertexts may correspond to a reference to wallet A 1805. In this example CB1 1835 can be an encryption of the reference to wallet A 1805 using the public key of the designated entity, while CB2 may be an encryption to the reference to wallet A 1805 using a public key of another designated entity. The references can be collectively shown in the form of a collection 1845 in FIG. 18. CB2 1840 may also be an encryption of another anchor reference. In accordance with some embodiments of the invention, using private keys matching the public keys using which ciphertexts were produced, parties with private keys can perform tracking by determining the corresponding references.

Multiple wallets may correspond to the same tracker. Multiple wallets may correspond to singular trackers when one user has registered multiple independent wallets. When multiple wallets exist, anchors may comprise biometric tokens, as disclosed in U.S. Provisional Patent Application No. 63/273,921, titled “Biometric Authentication using Privacy-Protecting Tokens,” filed Oct. 30, 2021, the disclosure of which is incorporated by reference herein in its entirety. Thus, users may use biometric tokens to unlock wallets, where biometric authentication can be governed by templates associated with the tokens. Anchors may correspond to usage profiles that describe the preferences of the associated users. Designated parties may be able to decrypt references associated with particular wallets and/or anchors, allowing them to cluster wallets.

In accordance with various embodiments, designated parties can also establish that wallets are not linked to existing clusters. Multiple designated parties may associated with wallets. When multiple designated parties exist, a quorum may be needed to collaborate to perform a tracking action. Designated parties may receive requests indicating a type of tracking action. An example tracking action may be to determine whether two wallets correspond to each other (are clustered). In a request, designated parties may receive ciphertexts associated with the trackers needed to perform the tracking request. Upon receiving the ciphertexts, the designated parties may be able to determine whether the trackers associated with the wallets correspond to the cluster. The designated parties may generate an output, including but not limited to a Boolean value indicating if the wallets are part of the same cluster. When multiple designated parties exist, generation of the output may depend on sharing private keys between the designated entities. Private keys may be shared using methods including, but not limited to threshold sharing schemes (e.g., using a polynomial secret sharing enabling a quorum of the designated entities to perform computations using the private key without disclosing or learning the same).

In accordance with some embodiments, records with identity information, corresponding to anchors, may contain references to the one or more wallets that reference them. This may take the shape of one or more trackers T1 . . . Tn, similar to tracker T, embedded in or associated with the anchor. Here, T1 can contain ciphertexts corresponding to a wallet identifier of the first wallet W1 associated with the anchor, T2 to ciphertexts corresponding to the wallet identifier of the second wallet W2, etc. These ciphertexts may be decryptable by a designated party, as described above. Multiple ciphertexts may exist for each anchor reference, enabling different designated entities, some of which may be distributed, to determine a wallet identifier, such as the wallet's public key, from the associated ciphertext. The tracker Ti, therefore, may include a ciphertext Ci, corresponding to a wallet public key W1. The wallet can generate the tracker Ti and prove that Ci is an encryption of the wallet public key W1. For example, using EIGamal encryption, the ciphertext may be of the format (Ai, Bi)=(X\hat{ }ri*Wi mod p, g\hat{ }ri mod p) where ri is a random nonce used to generate Ci. By proving log_X(Ai/Wi)=log_g(Bi), e.g., using a challenge-response protocol or a digital signature scheme like DSA, the format can be verified by a third party, including but not limited to a designated party. When there are multiple trackers, such as T1 and T2, the party generating the trackers can prove that the trackers correspond to the same wallet identifier, e.g., that decrypting T1 may result in the same plaintext as decrypting T2 would. Multiple trackers corresponding to the same wallet identifier may therefore be proven without requiring the decryption of the trackers. Designated parties can determine information including but not limited to whether two different anchors correspond to the same wallet; what wallets are associated with a given anchor, what wallets are associated with a given wallet, what anchors are associated with a given anchor, etc. Thus, the linking of the records identifying the wallets and the records identifying the anchors can enable seamless tracking by designated parties. Systems in accordance with some embodiments of the invention may perform tracking of various types without disclosing plaintext data. For example, such entities can determine whether two anchors correspond to the same wallet, without disclosing what wallet that would be, by determining the binary classification of correspondence.

In an example of cluster identification, a quorum of participants of a designated entity and/or a plurality of designated entities may cluster two or more wallets, linking together the wallets as belonging to the one or more designated entities. In accordance with some embodiments of the invention, ciphertexts {C1, Cn} associated with the one or more designated entities nay be extracted from the trackers of the wallets to be clustered.

In extracting the ciphertexts, the designated entities may establish blinded identifiers to be associated with the cluster. In an example instance, The value Pi\hat{ }N may be considered the blinded identifier and can differ between two clustering sessions since N can be chosen at random for each session. In the example, participants of a designated entity may collectively select a nonce N at random, through actions that may include, but are not limited to threshold secret sharing. In an instance where Ci=(Ai, Bi), the designated entities may generate the value Ci\hat{ }{N*x}=(Ai\hat{ }{N*x}, Bi\hat{ }{N*x}). The values can be computed in a distributed manner, and/or in a way that involves each participant proving correct computation relative to a share of the public key X of the designated entity. In accordance with some embodiments, Ci\hat{ }{N*x} can be set to equal Pi\hat{ }N when Ci corresponds to a plaintext Pi, and x is the private key of the designated party. However, for two trackers of two wallets indicating two anchors that are the same, the blinded identifiers can be the same. Similarly, the two trackers of two anchors indicating two wallet identifiers that are the same may result in two identical blinded wallet identifiers. Therefore, the designated entity, having completed the blinding and decryption, may be able to automatically cluster the wallets given the blinded identifiers, where these identifiers correspond to anchor references and/or wallet public keys.

Systems in accordance with some embodiments of the invention may influence tracking attempts based on wallet clustering. Tracking may involve the clustering of wallets associated with one or more transactions. Security actions may correspond to limiting the capabilities of wallets in such clusters. For example, the limiting of capabilities may correspond to not enabling such wallets to exchange cryptocoins for fiat currency, and/or not be allowed to use cryptocoins to purchase NFTs in marketplaces associated with the jurisdiction.

In accordance with some instances, a policy may be established that anchors are only used only for a small number of wallets (e.g., a single wallet, five related wallets). In clustering the wallets, systems in accordance with various embodiments of the invention may determine when requirements are violated. When one or more violations are detected, selective tracking can be performed, and security actions taken accordingly. One example security action may limit the rights of wallets to some resource, such as a marketplace. Another example security action may be for a digital rights management (DRM) module associated with a non-compliant wallet to refuse to render content. DRM modules may be incorporated in devices other than the wallets for which there is a violation, e.g., using the techniques disclosed in co-pending application titled “Cross-Device Digital Rights Management” by Markus Jakobsson.

Some ciphertexts associated with trackers may correspond to classifications as opposed to references. For example, one ciphertext may correspond to an encrypted version of a description of a jurisdiction, such as “Texas”. This jurisdiction may correspond to the residency of users of the wallet(s) with which the anchor is associated. Classifications can enable the sorting of wallets by jurisdiction, and the treatment of wallets and wallet requests according to their corresponding jurisdictions. Other classifications may include, but are not limited to, indicators of age of users, indicators of rights (such as the right to drive a car), and sexual preferences for the purposes of online dating and matchmaking. Such classifications can be stored in an encrypted manner and/or be possible to process for designated parties, (e.g., as described above using blinding). In accordance with a number of embodiments, statistics of the classifications can be determined by processing collections of ciphertexts using mix networks. Different ciphertexts may be associated with different designated parties, corresponding to what entities need the capability to perform controlled tracking and/or, when applicable, what entities are selected by the users to represent them.

Anchors may correspond to arrays of ciphertexts, each ciphertext identifying predicates of the associated wallet(s) and/or user(s). Examples of such predicates are the classifications described above, which may relate to entities including but not limited to users, locations, jurisdictions, preferences, wallet contents, and/or usage types. In accordance with some embodiments, the arrays can be compared to each other, clustered, and/or otherwise processed by ML entities. Such comparisons may be used to enable anonymized user profiles that can be used to identify traits including, but not limited to, needs, interests, demographic changes, and/or abuse. Such arrays may be applied in ways including but not limited to, arrays serving as input into machine learning classifiers that predict the likelihood of a user having an interest in a particular product, based on data about other users' interactions with said product or similar products; a company applying clustering and other analysis to such arrays corresponding to purchasers of a particular product to inform market segmentation; a dating service or social network employing clustering and/or distance metrics on such arrays to recommend users whose arrays are “similar” connect with each other; content recommender services employing such measures of similarity between users to recommend content based on what similar users have engaged with.

In accordance with a number of embodiments of the invention, many examples of tracking may exist. One form of tracking may be to cluster a collection of wallets or anchors based on their association with each other. Another form of tracking may be to cluster a collection of wallets and anchors based on them having a specified classification. Sample classifications may include, but are not limited to, belonging to a specified jurisdiction; corresponding to high-value investors; and corresponding to a specified behavior. As new wallets are created and/or new wallets, designated parties may determine whether the new wallets are associated with any wallets on alert-lists. In doing so, systems in accordance with various embodiments of the invention may use tracking and/or take corrective actions. Corrective actions may include, but are not limited to placing the new wallets on alert-lists and/or restricting wallet access in some manner.

Systems and techniques directed towards tracking transactions, in accordance with various embodiments of the invention, are not limited to use within NFT platforms. Accordingly, it should be appreciated that applications described herein can be implemented outside the context of an NFT platform network architecture and in contexts unrelated to the management of fungible tokens and/or NFTs. Moreover, any of the systems and methods described herein with reference to FIG. 18 can be utilized within any of the NFT platforms described above.

B. Reporting Transactions

In accordance with a number of embodiments of the invention, reporting mechanisms may be used on specific transactions, deriving and disclosing particular attributes about a given transaction. Logs and reports may be generated for purposes of auditing the consumption within NFT platforms.

Systems in accordance with numerous embodiments may be used to generate logs and reports by media processing units. This may, for example, be used for auditing the consumption of rich media such as movies and/or music. Auditing may be probabilistic. Auditing may be used to help determine, on behalf of consumers, whether their subscription and/or data plan is the most desirable. Auditing may be used to help determine, on behalf of consumers, whether they may potentially benefit from new plans. Auditing may be used for, but is not limited to, guiding determinations of royalty payments to artists, detecting whether sellers of rich media and/or physical goods are reporting sales correctly, and assessing whether anomalies result from cheating and/or malfunction. Accordingly, the technology is used in many embodiments to identify cheaters.

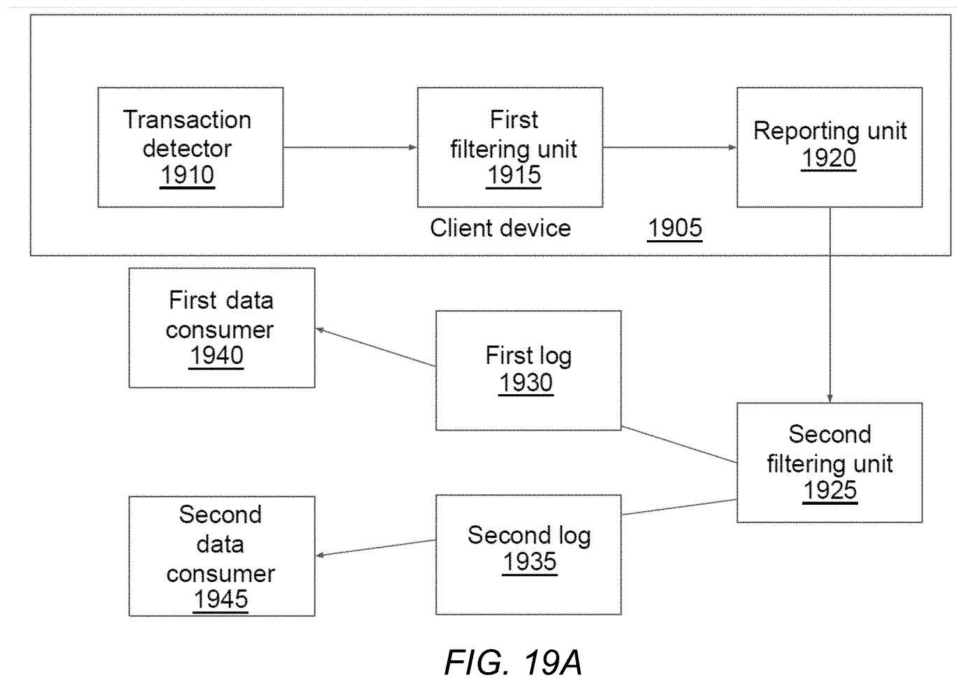

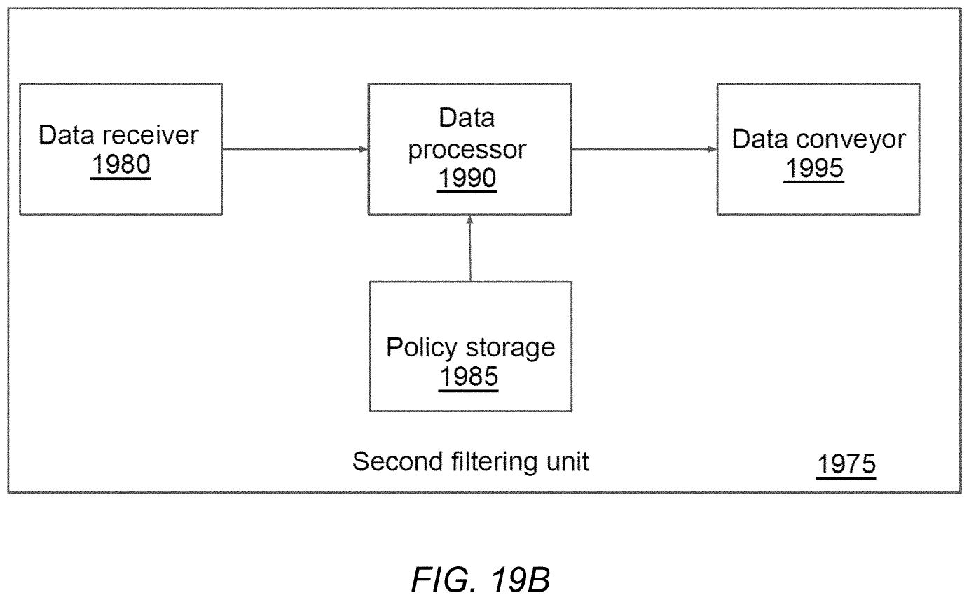

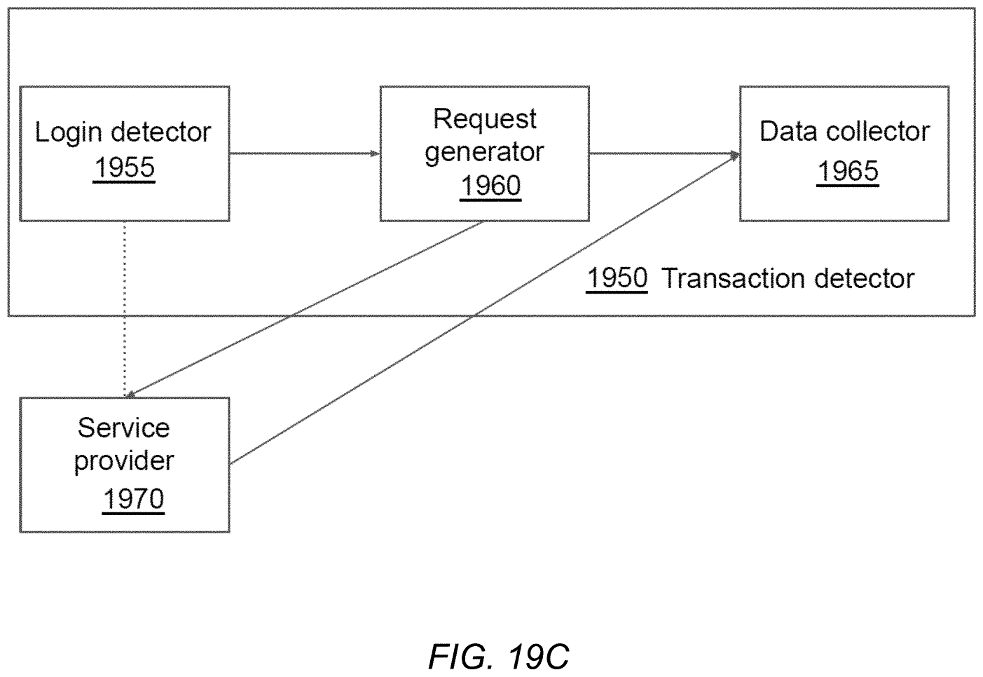

An example of a reporting and filtering process targeted specifically to transactions, in accordance with many embodiments of the invention, is depicted in FIG. 19A. Client devices 1905 in systems in accordance with such embodiments may include transaction detectors 1910 that detect when one or more transactions have taken place. Once transaction detectors 1910 note a transaction, they can send this information to first filtering units 1915. Transactions may go beyond purchases and include, but are not limited to, media content being accessed, viewed, rendered and/or consumed. Yet another form of transaction can relate to purchases that are made after related promotional content is shown. As such, systems in accordance with many embodiments of the invention may work in unison with the systems disclosed in U.S. patent application Ser. No. 17/806,728, titled “Systems and Methods for Encrypting and Controlling Access to Encrypted Data Based Upon Immutable Ledgers,” filed Jun. 13, 2022, the disclosure of which is incorporated by reference herein in its entirety.

In accordance with some embodiments of the invention, reportable transactions may encapsulate pre-determined events, such as vehicles being driven above a certain speed. In the above example, associated filters may identify when users are speeding and report such events to entities including but not limited to parents, rental car companies, and law enforcement. Within systems operating in accordance with some embodiments of the invention, filters may be located in devices including but not limited to infotainment systems, computers, and phones. Alternatively or additionally, filters can be implemented as executable code that is associated with crypto payment tokens.

When first filtering units 1915 receive data on the occurrence of one or more transactions, they may then determine what information, if any, should be reported and filter that information. Reporting may be done in a way that selectively discloses information. For example, in relation to financial transactions, reporting entities may disclose identifiers associated with the senders of funds and/or the recipients of funds. In this example, one or more identifiers may be in the form of pseudonyms, unique identifiers associated with the relevant entities, and/or entity classifications. In accordance with various embodiments of the invention, pieces of data may be both identifiers and pseudonyms. For example, user identities and pseudo-random values that change on a durational basis may be encrypted using public keys of the IRS. The IRS could then decrypt the relevant ciphertexts and obtain the identifiers. Any other party without the IRS public key would not be able to get the identifier.

For systems in accordance with several embodiments of the invention, users may be incentivized to connect reporting entities to one or more of the users' financial instruments, with optional filtering policies. One incentive to do so may be to earn points on transactions. Another incentive may be to receive cash-back bonuses. Yet another incentive could be to receive discounted services. Discounted services may include, but are not limited to, accounting services, better rates for a loan, and automated advice for discounted products of the type users may be interested in based on past purchases.

Reporting entities in accordance with many embodiments of the invention may be part of execution environments (EE) as disclosed in U.S. patent application Ser. No. 17/806,728, titled “Systems and Methods for Encrypting and Controlling Access to Encrypted Data Based Upon Immutable Ledgers,” filed Jun. 13, 2022, the disclosure of which is incorporated by reference herein in its entirety. Under certain circumstances, reporting may also be required, such as (but not limited to) by the IRS, for users that have failed to satisfy certain criteria in the past. For example, people who have under-reported their earnings may be required to automatically report all transactions. An employer providing an employee with a company credit card may choose to have all transactions be reported to the company's CPA, to identify abuse and problems in real-time, and to simplify filing expenses. Some countries and/or jurisdictions concerned with the use of crypto payments and their potential use for illegal transactions may require some form of reporting by all users within their borders. Alternatively or additionally, authorities may require reporting by all exchanges serving such users.

For systems operating in accordance with several embodiments, benefits may be derived even without access to all transactions. In such circumstances, the larger the sample size, the lower the expected error may be and the faster the conversion of any trend estimate can become. For example, when 1% of a population of users enables reporting to a given entity, this entity may be able to identify trends with a 95% accuracy. However, if the same entity had access to a sample corresponding to 3% of the population, it may be able to achieve an accuracy of prediction of 98%, and at half the time. The speed of the conversion may be of relevance to, but are not limited to, detecting and counter abuse before it grows too much, rapidly manufacturing more products before they run out, and/or providing beneficial services to users of the data, including the reporting entities, in a timely manner.

In accordance with many embodiments, first filtering units 1915 may generate multiple data representations from the filtered transaction information. The first filtering units 1915 also may encrypt and label at least some of the filtered transaction information. First filtering units 1915 can then convey the filtered information to reporting units 1920. In accordance with some embodiments, reporting units 1920 may be held within user devices 1905.

In accordance with some embodiments, reporting units may take multiple forms. Reporting units may be associated with client devices associated with sellers. For example, reporting units may be integrated in and/or associated with point of sale cash registers. As receipts are generated for buyers, the same or similar data may be encoded into logs, and reported to filters and/or data-consuming entities. Reporting units may be associated with consumer devices used for, but not limited to, claiming ownership of pieces of merchandise, registering warranties, and/or determining device authenticity. Reporting may be part of the functionality to perform other actions, such as reporting items as stolen. Examples of these types of uses and contexts are provided in U.S. Provisional Patent Application No. 63/019,178, titled “Ascertaining Authenticity and Ownership Using Interactive Identity Tags,” filed May 1, 2020, and U.S. patent application Ser. No. 17/198,123, titled “Managing Ownership and Access,” filed Mar. 10, 2021, both incorporated in the entirety by reference.

The user devices' reporting units 1920 may optionally convey filtered information to a second filtering unit 1925. Filters can be located, at least in part, on consumer client devices including but not limited to a phone used for payments, a laptop used to log in to a bank or credit card company site, and/or a tablet used to watch movies.

The filtering and reporting process may be performed continuously, with new transactions reported as they take place. The filtering and reporting process may also take place in batch mode. Batch-type filtration/reporting processes may engage as someone accesses their account. Alternatively or additionally, agents may scan content available on portals, and optionally request the relevant content through modes including but not limited to browser plugins, statements, Graphical User Interfaces (GUIs), etc.

In accordance with some embodiments, reporting elements may also be associated with crypto payment methods. For example, reporting elements may be linked to crypto payment wallets and/or one or more coins in crypto wallets. Reporting elements, which may have filtering capabilities, may be associated with coins in the form of executable elements. When coins are transferred, the executable elements can run, causing a set of actions to take place. In accordance with a number of embodiments, one action may be an optional filtering action while another is a reporting action that is optionally based on the filtering action.

In accordance with some embodiments, reporting elements may include filters that are associated with user accounts including but not limited to bank accounts, credit card accounts, money market accounts, debit card accounts, cell phone payment applications, etc. Associations with user accounts may be made in the form of, but are not limited to plugins, user selections, agents representing the users and interacting with servers representing the account management, etc. In accordance with many embodiments, filters may have secure access to user account(s), e.g., using a secure API. In one example, users may grant access to their accounts in a read-only manner using OAUTH. Filters may report the data they access and/or they may selectively report data, e.g., based on privacy settings configured. For example, payment related to categories users wish to stay private can be excluded from reports that are generated through filters.

Systems in accordance with many embodiments of the invention may utilize multiple layers of filtering. For example, filters on client devices may collect information and transmit the data to web servers that perform additional filtering. Second layers of filtering may cause multiple logs to be generated and made available to third parties using one or more methods.

Logs may be communicated in a variety of methods, including but not limited to in a pull and/or push fashion over APIs; by being written to shared-access spaces, such as folders that are synchronized to a cloud storage service by a local software client application; by being transmitted using FTP to upload sites, etc. Logs can also be written in public storage spaces, such as decentralized databases, and/or placed in full or in part of blockchain ledgers. In accordance with some embodiments, log data may be selectively encrypted. Entries may also be authenticated, e.g., by one or more of the filtering entities processing the data. Authentication approaches may include, but are not limited to message authentication codes (MACs), digital signatures, and/or similar techniques. Authentication may be performed, but is not limited to, on a per-element basis, before or after elements are encrypted, and/or in multiple elements. In such cases, one element may account for one or more reported transactions.

A configuration for a second filtering unit, in accordance with a number of embodiments of the invention, is illustrated in FIG. 19B. Second filtering units 1975 may include data receivers 1980 that receive data from one or more reporting units. Received data may be conveyed to data processors 1990 that perform transformations on the received data. Transformations may be based on, but not limited to, policies stored in policy storage 1985. Example transformations may include, but are not limited to aggregations, generations of estimates and predictions, changes to and removals of labels, identifiers and pseudonyms, and encryptions of partially transformed data. Data conveyors 1995 may generate one or more logs and/or log entries based on the transformed data. In accordance with various embodiments of the invention, logs and log entries may be made available to one or more data consumers.

In accordance with many embodiments, scanners used to verify what merchandise is to be sent and/or has been received may generate log entries. For example, when a shipper receives a pallet of merchandise, a person may scan a QR code associated with the pallet to verify receipt and create one or more logs. This functionality is described in U.S. Provisional Patent Application No. 63/019,178, titled “Ascertaining Authenticity and Ownership Using Interactive Identity Tags,” filed May 1, 2020. and U.S. patent application Ser. No. 17/198,123, titled “Managing Ownership and Access,” filed Mar. 10, 2021, both incorporated in the entirety by reference. This may be used to create audit logs for receipt and ownership of products. Similar methods can be applied to virtual goods. As the scan is made, or otherwise, the data is processed, logs may be generated and fed to one or more filters or data consumers.

Data conveyors 1995 may cause transformed data to be stored in databases, including but not limited to decentralized databases, ledgers, proprietary databases, or a combination of such. Data conveyors 1995 may be configured to enable access by data consumers. Access may enable using interfaces including, but not limited to, APIs, where access can be end-to-end protected using secure channels.

In accordance with a number of embodiments of the invention, filters may also be located on remote servers. Filters located on remote servers may be maintained by service providers receiving associated logs. Additionally or alternatively, filters may be maintained by entities performing reports. Remote servers may receive data feeds from an end-user client device accessing a service and/or being used to perform a transaction, and/or from an executable token that is part of a crypto payment. Remote servers may receive data using APIs, from third-party service providers. Remote servers may process data on behalf of the associated consumers and/or end-user entities, and generate one or more log entries from the processed data.

In accordance with several embodiments, filters can be implemented as executable code that is part of and/or associated with crypto payment tokens. When such tokens are used in transactions, smart contracts may be executed that include and/or initiate calls to filters. In accordance with a number of embodiments, filters can be separate executable elements and/or part of smart contracts. Thus, in response to executing the smart contract, whether in part or in full, report log entries may be generated. Executions of smart contracts may be “in full” if they result in transactions, and “in part” if they attempt to perform transactions but fail to, e.g., due to a shortage of available units of product.

Smart contracts can also be associated with the fulfillment of DRM-governed transactions. DRM-governed transactions may include, but are not limited to viewing movies and playing songs. DRM-governed transactions can be reported as well. In such cases, the transactions may not have the format of a sender and a receiver. Alternatively or additionally, senders and/or originators of content may be implicit in the transaction as they may be directly associated with content identifiers. In accordance with some embodiments of the invention, receivers (e.g., users of content), may be relevant to explicitly report by identifiers and/or pseudonyms. Other information that may be reported includes, but is not limited to whether the entire content was rendered; whether the playback was stopped; whether the user played any portion many times, in slow motion, skipped ahead, etc.; and/or information on background environments. Example situations in which background environments are reported may include when a phone call comes in and causes playback to be halted and/or a user stops playback. As such, reporting external events may include but is not limited to the receipt of phone calls, background noise in the area of playback, or a timer on the device resulting in an alarm, etc.

Second filtering units 1925 may receive data from a plurality of devices. As such, the second filtering units 1925 can aggregate data from multiple client devices such as client device 1905. Aggregators of log information may create estimates of the real quantity/volume of a transaction type associated with a given log, based on the log entries recorded in one or more logs. Some filters can aggregate data from multiple originators, and/or facilitate decision-making based on such data. Some kinds of aggregation may involve the reporting of averages. Various kinds of aggregation may be used to indicate trend curves. A number of kinds of aggregation can report the count of transactions of a particular type. Based on the recipients of logs and/or the usage of logs, different forms of aggregation and other transformations may be performed. In such cases, the results of the transformations may themselves be incorporated in logs.

In accordance with some embodiments of the invention, aggregators may generate one or more estimates using machine learning (ML) components. Machine learning components may be trained in settings where the baseline truth is known through methods including but not limited to downsampling complete information, generating estimates of the full volume based on the downsampled volume, and/or modifying parameters until the estimates are correct. Systems in accordance with several embodiments may be trained through the use of simulated transactions, based on models of transactions that may be informed by the transaction logs that are collected.

In accordance with a number of embodiments, artificial intelligence (AI) components may be trained to predict and/or estimate quantities, and used alongside or in place of machine learning elements. Additionally or alternatively, rule-based methods of estimating volume and confidence intervals can be implemented. In accordance with some embodiments of the invention, a combination of such methods, including rule-based, ML-based and AI-based methods, may be used to generate estimates of volumes and confidence intervals. In some example usage situations, competing components may be given different down-sampled datasets, each competing to provide estimates of the underlying quantities.

In accordance with numerous embodiments, aggregators may also be directed to determining anomalies and/or outliers. Based on the volume and severity of anomalies associated with reporting units, the reporting units can be given lower trust scores. Lower trust scores may result in reporting units' certifications to process content and transactions being reduced. Additionally or alternatively, reporting units with trust scores beneath certain thresholds can be flagged for in-depth assessments. For example, a unit may be assessed to determine whether it is affected by a computer virus and/or other malware. This anomaly-based assessment can be performed in a centralized manner. Anomaly-based assessments may be used as a way of determining the reliability of individual devices and/or units and devices and/or units using various computational platforms. Computational platforms may include, but are not limited to trusted execution environments (TEEs) and/or digital rights management (DRM) tools. Assessments may be associated with computational platforms with a particular operating system, browser type and/or version.

Upon receiving aggregated information, the second filtering units 1925 may generate one or more logs 1930, 1935 from that filtered information. FIG. 19C shows the generation of a first log 1930 and second log 1935. A given log may be associated with a transaction of a given classification. In some examples, parties to transactions may remain unidentified in the logs that are generated. An example classification may be the amount of hard drives sold, by zip code(s) associated with the buyer and/or seller. Another example classification may be total amount of sales of a specific seller. A third example classification may be the types of purchases and associated amounts for a male of age 20-24. Therefore, if a 21-year-old male associated with zip code 94041 buys a hard drive for $100 from Acme Electronics in zip code 94040, this transaction may be registered in multiple logs. The logs may include the log for hard drives sold to buyers in zip code 94041; the log for hard drives sold by sellers in zip code 94040; the sale of an item worth $100 by Acme Electronics; and a purchase of electronics for $100 by a male in the age range 20-24.

In accordance with some embodiments of the invention, the first log 1930 may be transmitted by the second filtering unit 1925 to a first data consumer 1940. The second log 1935 may be transmitted from the second filtering unit 1925 to a second data consumer 1945. Transaction data may be provided to receiving data consumers in return for some benefit. Transaction data may also be donated to an organization that collects consumer data and donates the proceeds to charity. Transaction data may also be requested by a third party including but not limited to law enforcement, employers, and/or by another entity with influence over the relevant part, such as a parent and/or a counselor. The provision of data to data consumers can be conditional on some type of filtering, aggregation and/or transformation. The first data consumer 1940 may be an entity that generates consumption predictions. The second data consumer 1945 may determine fraud and abuse, and/or generate estimates of sales to support such determinations. Users associated with the client device 1905 may specify one or more policies that determine the operation of the first filtering unit 1915 and/or the second filtering unit 1925. The one or more policies may include what types of data is being reported and to what entities.

FIG. 19C illustrates an example transaction detector 1950 in accordance with some embodiments of the invention. Transaction detectors 1950 may include login detectors 1955 that determine when consumers access service providers 1970 that maintain transaction data for one or more end users. Transaction detectors 1950 can initiate the login detectors 1955 when logins are determined. In accordance with several embodiments of the invention, request generators 1960 can create one or more requests that are provided to service providers 1970. An example request may be to access a statement enumerating transactions, and initiate a data collector 1965 after transmitting a request. Data collectors 1965 can receive responses from service providers 1970 and verify their validity. The data collectors 1965 may convey collected and verified information to filtering units.

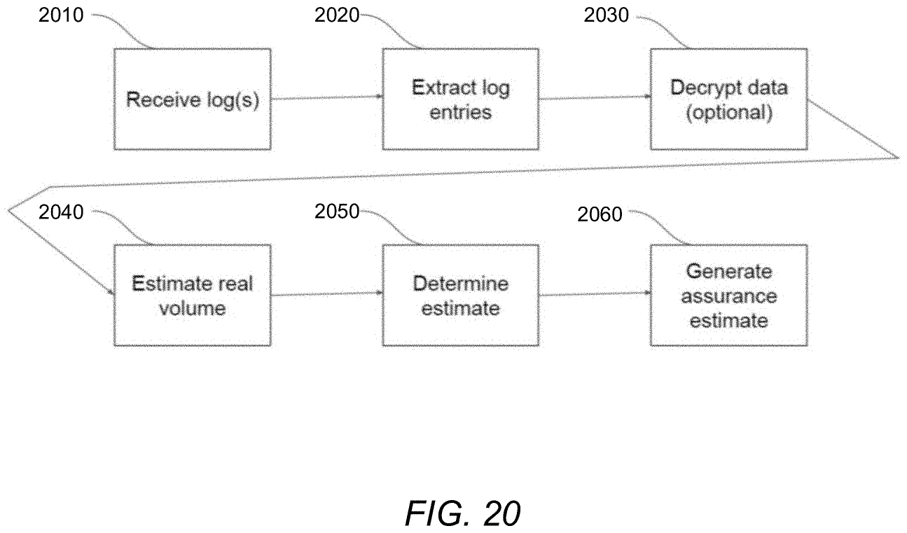

The process of data filtering performed by a sample filtering unit in accordance with several embodiments of the invention, is depicted in FIG. 20. Process 2000 may receive (2010) logs including transaction data. The logs may come from an application including, but not limited to, an additional filtering unit connected to the sample filtering unit, a reporting unit appended to the sample filtering unit, and a reporting unit on an external device. Process 2000 may extract (2020) log entries upon receipt. Extraction may require verification of authenticity related to a communication channel over which the logs were received. The extraction may include, but is not limited to, verifying the validity of entries, associating entries with type descriptors based on labels and/or other indications of type, and normalizing categories and/or type descriptors. In accordance with some embodiments, the process 2000 may decrypt (2030) log entries. In accordance with a number of embodiments, data may remain encrypted when computed upon. Process 2000 may estimate (2040) a transaction volume from one or more log entries from which data has been extracted. Process 2000 may determine (2050) estimates of additional quantities.

One example quantity to be estimated may be the weight that is associated with log entries. Weight may be used to indicate the risk and/or the accuracy associated with the originator of the associated data value. For example, a weight that is set at 100 may correspond to a trusted originator with a non-anomalous reporting history. A log source originator may be determined to be trusted if it uses environments including, but not limited to, a trusted execution environment (TEE) of at least a minimum standard, and/or a digital rights management (DRM) module with a rating exceeding a required minimum. In the above example, a sample weight of 45 may be associated with an originator that is not trusted, but has a non-anomalous reporting history that exceeds a minimum number of reports. A weight of 12 may be associated with an originator with suspected anomalous reporting behavior.

A second example quantity may be a weighted average. For example, two logs may be received, including values V1 and V2, wherein these two values are associated with originators with weights W1 and W2. In such a case, a weighted average of the values may be V=V1*W1+V2*W2. A similar computation may be performed on encrypted values E1 and E2, where E1 is a homomorphic encryption of V1 and E2 is a homomorphic encryption of V2. An example homomorphic encryption method can be EIGamal encryption. Using EIGamal encryption, an encrypted weighted average can be computed as E=E1 \hat{ }W1*E2\hat{ }W2 (wherein A denotes modular exponentiation, and*modular multiplication). Process 2000 may generate (2060) an assurance estimate. This may be a confidence interval, a variance, and/or a value describing risk, which may be generated from one of the above values.

In accordance with several embodiments, risk scores can be determined for general platforms, indicating for example that a given old operating system is high-risk. Risk scores may cause some content providers and/or transaction managers to refuse to interact with such platforms. Additionally or alternatively, risk scores may lead transaction managers to require additional assurance before an interaction takes place. One example of an assurance may be an insurance token, as described in co-pending application U.S. patent application Ser. No. 17/811,853, titled “Artifact Origination and Content Tokenization,” filed Jul. 11, 2022, incorporated herein in the entirety. Other examples of assurance may include, but are not limited to required anti-virus scans and/or software-based attestations that must be performed before transactions are approved.

As indicated above, filtering units may be used for selective reporting of transactions based on one or more policies associated with users. Particular policies may have been set and/or approved by users and/or user representatives, based on requirements in a local jurisdiction, based on a requirement by a judicial/law enforcement entity, and/or based on an employer's requirements.

Systems and techniques directed towards reporting and/or filtering transactions, in accordance with various embodiments of the invention, are not limited to use within NFT platforms. Accordingly, it should be appreciated that applications described herein can be implemented outside the context of an NFT platform network architecture and in contexts unrelated to the management of fungible tokens and/or NFTs. Moreover, any of the systems and methods described herein with reference to FIGS. 19A-20 can be utilized within any of the NFT platforms described above.

C. Reporting Token-Associated Events

In accordance with many embodiments of the invention, reporting could enable manufacturers, retailers, and advertisers engaged with NFT platforms to learn about how products and services are acquired by consumers. Such engagements may help improve products and their marketing, as well as enable more streamlined distribution. As such, another possible reporting mechanism may be used to disclose select events and/or actions associated with NFTs to chosen recipients, providing substantial insight from the use and transfer of NFTs.

In accordance with several embodiments of the invention, event-reporting processes may enable select events associated with NFTs to be reported to one or more recipients. Example events may include, but are not limited to, an ownership transfer of an NFT, a rendering of an NFT, a check-out of the NFT, a purchase request associated with the NFT, and/or “likes” (e.g., positive feedback) of the NFT. Different types of events may be associated with different needs to report. For some jurisdictions operating in accordance with various embodiments of the invention, requirements to report changes may be established under certain circumstances. For example, a jurisdiction may require reporting of ownership when purchase prices for NFTs exceeds a threshold amount. Systems operating in accordance with some embodiments of the invention may allow NFTs to be sponsored by advertisers and/or made accessible to users wishing to render the NFTs in given scenarios. Scenarios may be met when user devices used to access and/or render NFT content reports some minimum information related to the access. Minimum information may include, but is not limited to information related to the users of the relevant devices (e.g., zip code) and/or temporary pseudonyms associated with the relevant devices.

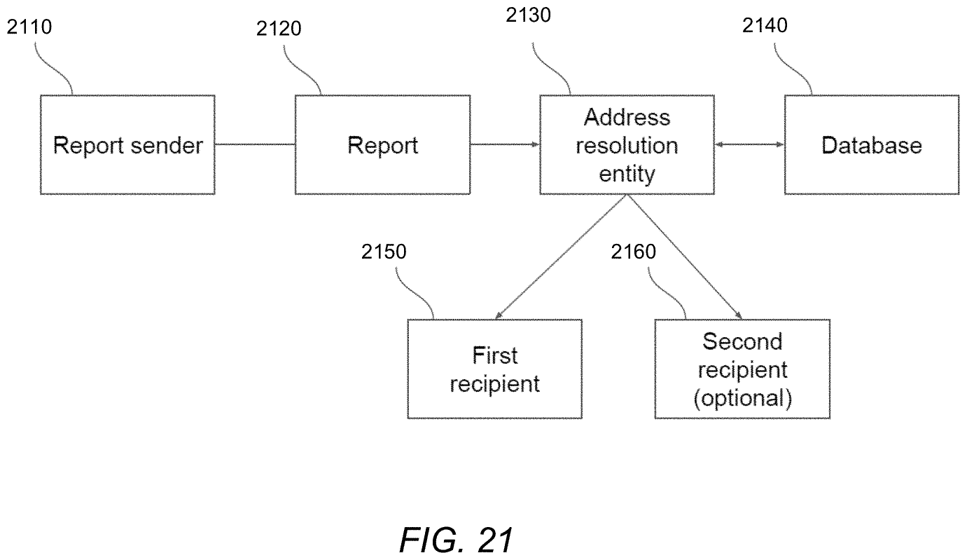

An example of an NFT event reporting system in accordance with many embodiments of the invention is depicted in FIG. 21. Report senders 2110 (i.e., reporting mechanisms) may transmit reports 2120 to be routed to address resolution entities 2130. Address resolution entities 2130 can be examples of report intermediaries. The reports 2120 sent by report senders 2110 may include information about particular events. The information included in reports 2120 may concern events that triggered the generation of the reports 2120.

In accordance with several embodiments, reporting mechanisms may be contained within NFT smart contracts in several forms. In such cases, the output of the reporting mechanisms may be contained on blockchains, off-chain, and/or communicated to 3rd-party systems. When on-chain, reporting mechanisms may nevertheless exist outside the specific NFTs relevant to particular events (e.g., when multiple NFTs are reported on). When off-chain, reporting mechanisms may exist as, but are not limited to bounty hunters that are incentivized to seek out valuable information. The reporting mechanism may be off-chain in the form of reverse-oracles that report and track on-chain activities. Reverse oracles may report activities to off-chain resources and/or on-chain resources (e.g., adding new blocks to a blockchain). Reporting mechanisms may be represented, at least in part, by one or more rules and policies that are part of an NFT, and which can be readable by external entities.

In accordance with a number of embodiments, NFTs can implement the reporting functionality by having an executable component that generates reports as NFTs determine events. For example, an NFT may store a state, in the NFT and/or on an external storage location where the state value may indicate the NFT's ownership. A storage location may be, but is not limited to blockchain and/or other public databases. In accordance with some embodiments, NFTs, upon activation, may determine and report whether current execution environments are indicative of changes in ownership using the executable component.

Systems in accordance with several embodiments may apply executable components in varying ways. Executable components may, as NFT content is accessed, determine whether the access is reportable. When the access matches reportable events, NFTs may initiate reports. Additionally or alternatively, executable components may be part of smart contracts wherein transactions regarding the corresponding NFTs cause the evaluation of the executable components and/or initiation of reporting. The executable component may include one or more addresses to which to report. Additionally, executable components may incorporate addresses predetermined to receive reporting. Said reports may come in a variety of forms including, but not limited to, directly from the NFT's execution environment, and by an intermediary associated with the execution environment.

In accordance with some embodiments, NFTs can include data fields that indicate the conditions under which reports are requested. For example, in the case of a “like” expressed on a social media platform, a social media provider may be obligated to submit a log report related to the like of the specific NFT to comply with the terms of service of the NFT originator. In such examples, terms may be expressed as rules and/or policies associated with NFTs, and embodied in the data fields that indicate the conditions of use. Reports, in the context of social media, may identify the number of likes and/or the demographic profiles of the users initiating the likes. In transmitting reports, systems in accordance with a number of embodiments may exclude identifiers associated with the relevant profiles. Originators of the relevant NFTs may receive copies of reports transmitted. In doing so, the originators can use the reports to learn what groups of users, expressed in terms of their demographics, like their NFT content.

Data transmitted to a first recipient 2150 may be taken from reports in a manner including, but not limited to all of the report 2120, a portion of the report 2120, and/or a function of the report 2120. Recipients may receive aggregates of multiple reports. These processing actions may be examples of filtering processes performed on the reports. The type of filtering to be performed may be determined based on a lookup in the database 2140.

In accordance with some embodiments of the invention, reporting mechanisms may include privacy filters. Privacy filters may collect reports from user devices, anonymize the reports, and/or transmit the anonymized reports to recipients. Any anonymizing process may be in full and/or in part. In accordance with several embodiments, anonymizing processes may be implemented by intermediaries. Intermediaries may aggregate data concerning multiple events from the same execution environment and/or from multiple different execution environments in which related events occur. Hierarchies of intermediaries may be used which may hide the origin and/or aggregate data received from intermediaries feeding data to it.

As intermediaries process data, they may also aggregate data reports. In accordance with various embodiments, aggregated data reports can be provided to subscribers other than the specified recipients of reports, where permitted by the reporting execution environments and the associated report recipients. Aggregated reports may be aggregated and/or anonymized, and comply with requirements associated with the NFTs about which reports are being made.

The data transmitted to optional second recipients 2160 may be different from the data transmitted to first recipients 2150. For example, the difference may result from a different filtering process, such as anonymization. The determination of how to generate the data transmitted to the first recipients 2150 and/or optional second recipients 2160 may be conveyed in various ways. These ways may include, but are not limited to being conveyed in the report 2120, being stored in the database 2140, and/or being in records associated with the report 2120 and/or the recipient of data.

In accordance with various embodiments, report senders 2110 may correspond to DRMs executing code in TEEs. The addresses of the address resolution entities 2130 can include domain names, through which reports 2120 may be addressed. The address resolution entities 2130 may consult databases 2140 to resolve addresses indicated in reports 2120 to one or more recipient addresses. The address resolution entities 2130 can then transmit data to the one or more recipient addresses. For example, the recipient addresses may correspond to a first recipient 2150 and optional second recipient 2160.

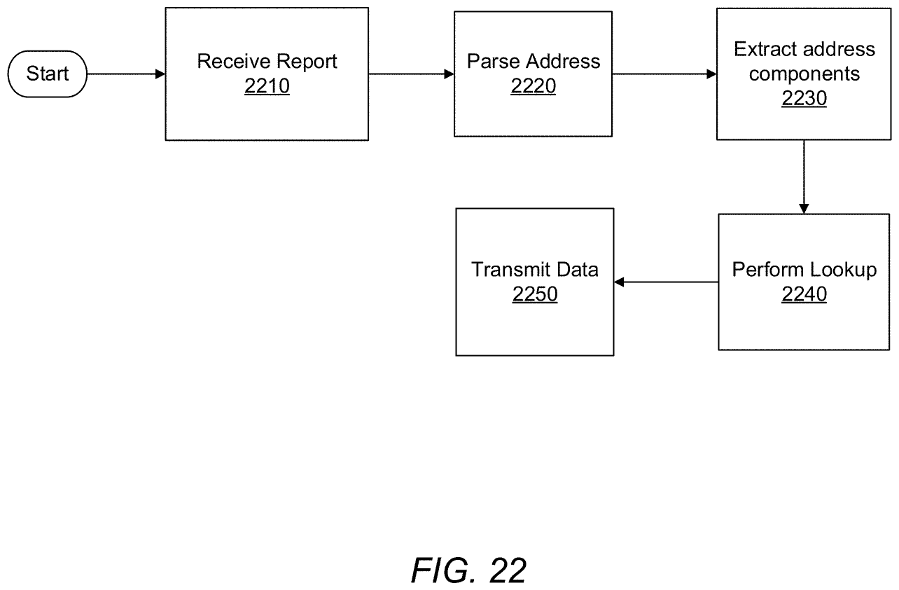

A process that may be followed by an address resolution entity, in using DNS lookup services to rout reports on particular events, in accordance with various embodiments of the invention, is illustrated in FIG. 22. Process 2200 receives (2210) the report or a portion thereof. Process 2200 parses (2220) the address of the recipient. Process 2200 may parse (2210) addresses of recipients into entities including but not limited to, a domain, a subdomain, a path, a user name, etc. For example, a URL (e.g., artistalice.acme.com/contentABC) may be parsed by an address resolution entity (e.g., associated with domain acme.com) into an originator-specific subdomain name (e.g., artistalice) and a content-specific path (e.g., contentABC). In another example, an email address (e.g., artistalice.contentABC@acme.com) received by an address resolution entity (e.g., managing acme.com), may be parsed to extract an originator-specific portion (e.g., artistalice) and a content-specific portion (e.g., contentABC).

In accordance with some embodiments of the invention, addresses, such as URLs, email addresses, etc., may also include encoded elements. Encoded elements may indicate, but are not limited to, originators (and/or other content service providers) and content-specific identifiers. For example, a URL (such as g6h885ndw1.acme.com) can have an encoded element (e.g., g6h885ndw1) that may identify a service provider as well as a content element. In another example, a URL (such as contentABC.artistalice.com) may be controlled by an originator of content (such as an artist named Alice), but mapped to a service provider (such as acme.com), by mapping the domain (e.g., artistalice.com) to an IP address controlled by the service provider.

Process 2200 extracts (2230) one or more address components. Extracted address components may identify at least one of a content provider, a recipient of reports, a content-specific identifier, and other contextual information that enables reporting associated with content. Process 2200 performs (2240) one or more lookups. In performing (2240) lookups, process 2200 may use the one or more components extracted as keys in a database lookup. In accordance with several embodiments of the invention, database lookups may enable the determination of one or more entities to transmit data to. Further, database lookups may determine whether to perform a function based on the received (2210) reports. Process 2200 transmits (2250) data to the one or more entities. Transmitting (2250) data may include, but is not limited to, forwarding the received (2210) report to the recipients determined by the performed (2240) lookup.

In accordance with some embodiments of the invention, the service providers set to receive reports may be re-designated. Re-designation may involve mapping DNS records for pre-set address resolution entities to a new address resolution entities. For example, Alice may control the mapping between the domain artistalice.com and a service provider, such as acme.com. This may be done by mapping the domain artistalice.com to an IP address controlled by acme.com. Alice may use acme.com as the address resolution entity, but wish to instead use the competitor notacme.com. Alice can obtain an IP address of notacme.com. Alice may then modify the DNS records for artistalice.com to map to the IP address of notacme.com. This may effectively cause reports generated in association with events on content generated by Alice, to be transmitted via notacme.com and its servers instead of via acme.com. In accordance with some embodiments, modification of the DNS records of address resolution entities may be limited to users and/or user-authorized entities, ensuring the re-designations may be secure. Alice, if she wishes to, can use subdomains in URLs, e.g., paintings.artistalice.com and movies.artistalice.com, enabling her to create different mappings corresponding to different subdomains. This may thereby create content-type specific reporting using different service providers.

For systems operating in accordance with several embodiments of the invention, indications of what entities receive reports can also be controlled by different controlling entities (e.g., address resolution entities). Reports sent to data recipients by address resolution entities may be addressed using domain names, e.g., similar to how the reports are addressed. A first authority (e.g., Alice) may perform a modification to a DNS database, as described above. Modifying a DNS database may cause remapping of the IP address (and therefore also potentially service provider) that receives reports and/or data transmitted to the recipients. At the same time, tax authorities may operate as additional recipients as well as additional controlling entities. Tax authorities may control where tax-related reporting is performed by updating DNS databases for domains used to transmit data. When the addresses through which recipients receive are content-specific and/or originator-specific, additional controlling entities may control where reports are transmitted. Control of where reports are transmitted may be done on a fine-grained basis, without having to modify any records in the database. When, for example, some reports should simply be processed for the creation of a tax bill, this can simply be controlled by updating the DNS records. Alternatively or additionally, recipients (e.g., an additional controlling entity) may determine where to route received data, just like address resolution entities can.

Systems in accordance with some embodiments of the invention may be used to incentivize users to report transactions themselves. For example, users who invest in NFTs may wish for third-party information collectors to automatically receive information related to the purchase and sales price of each NFT and/or the offer prices for each NFT. Users may use this functionality to report information about NFTs to prospective buyers and/or sellers independently of offers. Such functionality can enable collections of investment profiles to identify user strengths and/or enable determinations of likely features of NFTs and NFT transactions that are indicative of later increases in valuation. In accordance with several embodiments, sets investment behavior from a first investor may be compared to investment behavior from a second investor to determine the most beneficial investment approaches.

Systems in accordance with various embodiments may enable service providers to cluster collections of investment behaviors based on their characteristics. Characteristics may be described by features determined by machine learning (ML) elements. Features describing characteristics of investment behaviors may relate to, but are not limited to, tokens, their classifications, the bidding behavior of bidders as the tokens were acquired, and more. Such features can be determined at the time of the acquisition of the token and/or at later points. Clustered collections of investment behavior can enable users to determine correlations with expected increases in value for time horizons and/or points in time, determine the variance within clusters, and/or determine likely features of tokens and token transactions that may indicate later increases in value.

NFT investors may wish to subscribe to insights as is described above, and may follow changes of insights over time. Some embodiments of the invention may enable monetization of service provisions in the form of insights into patterns that are desirable (from an investment perspective) without the exposure of individuals' private information. Intermediaries that process data may engage in services related to providing privacy to end users. By providing privacy-enhancing services, intermediaries may be trusted with user data by end users helping them make predictions that help guide investments. Intermediaries may simultaneously benefit from the large amounts of data they are trusted with through systems including, but not limited to advertisements. In addition to using insights to make better investments, intermediaries may use them to provide content producers with rapid feedback indicating what content of theirs is likely to be appreciated. Here, artists (and other content producers) can use this feedback to focus on the creation of content that people love the most, and/or which awards content creators the most.

Systems in accordance with several embodiments may allow content producers to require that percentages of each sale (e.g., to NFT investors) be paid to them. For instance, content producers may require that 5% of each sale and/or 10% of each sale that exceeds $1000. Such mechanisms may be implemented using smart contracts, as disclosed in U.S. patent application Ser. No. 17/808,264, titled “Systems and Methods for Token Creation and Management,” filed Jun. 22, 2022, the disclosure of which is incorporated by reference herein in its entirety, and could be audited using the reporting mechanisms provided herein. When using audits under these circumstances, notable discrepancies between two or more assessments can imply potential anomalies, which could then be investigated.

Artists may wish to determine how their artwork, and/or other NFT-directed content, increases in value over time. Artists may also want information related to ownership transfer events associated with NFTs for which they created the content. They may wish a third party to collect these statistics, so they may want that third party to be the designated recipient.

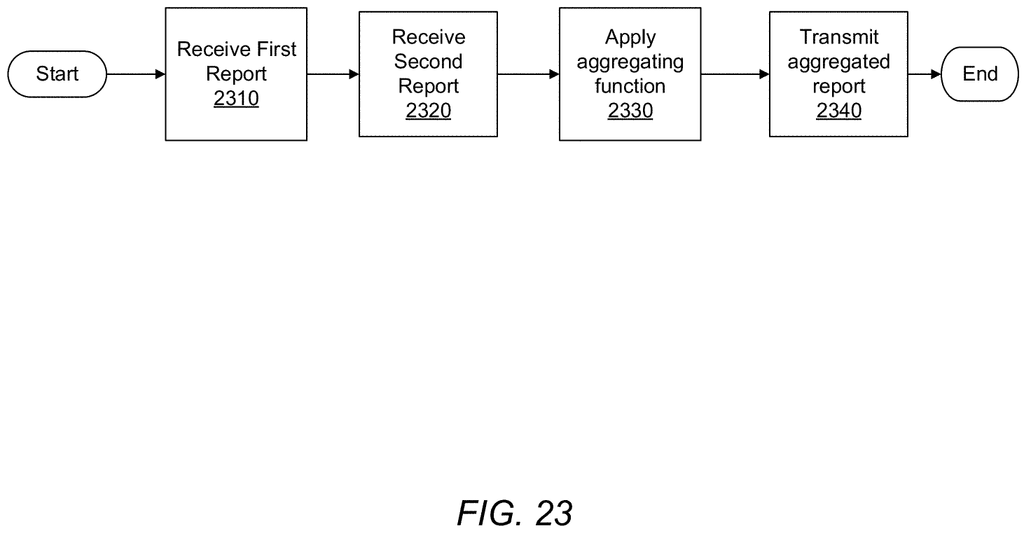

A process followed by a service provider in processing event reporting statistics, in accordance with numerous embodiments of the invention, is illustrated in FIG. 23. Process 2300 may operate through service providers, which may include but are not limited to address resolution entities and/or collaborating entities. Process 2300 receives (2310) a first report. Process 2300 receives (2320) a second report. In accordance with several embodiments, the reports, and/or data derived from them, may be stored and/or buffered upon receipt. Process 2300 applies (2330) an aggregating function is applied to data associated with first report and second report, resulting in an aggregated report. Process 2300 transmits (2340) the aggregated report. In accordance with some embodiments, aggregated reports may include, but are not limited to data transmitted in 2250. Aggregated reports may remove at least some identifying data from the one or more of the reports, such as an identifier of the sender.

Artists and other content creators may wish to replace the service providers performing collections of statistics. Therefore, recipient addresses may indicate logical recipients rather than physical recipients. In such cases, authorized entities may be able to provide mappings from logical to physical recipients, through mappings kept in registries. In accordance with several embodiments, recipient addresses may include domain names, and/or registries may be DNS servers that map between URLs and IP addresses. Content creators may control the associated domains and/or sub-domains of recipients. Content creators may generate mappings of URLs to service provider IP addresses, including one or more servers, for example. Mappings may enable content creators to change the indicated recipients for reports of statistics, from a first provider to a second provider. In accordance with some embodiments, primary service providers may perform the service of collecting statistics and re-transmitting the statistics to one or more secondary service providers. In such cases, the secondary service providers may have addresses stored in memory associated with the primary service providers, while the associated URLs resolve to the primary service providers.

Thus, content creators and/or processors with rights to control, at least in part, the reporting of statistics, may add and/or remove recipients in lists stored by other recipients (e.g., service providers) indicated by URLs resolved to IP addresses. If the content creators wish to replace service providers, then they can modify the resolution of the URLs to indicate new recipients. Once done, the modified URLs may then perform the services of retransmitting statistics and other information to one or more other recipients. Retransmission can be done, again, by transmitting requests to URLs, again allowing the individual replacement of recipients. The control of the aforementioned replacement of recipients can be managed by first-layer recipients of statistics and other data, the content creators, other content producers, or third-party entities. Systems in accordance with numerous embodiments may use additional address indicators beyond URLs. For example, an address for receiving statistics and other information can, instead of being a URL, be represented by an email address. Like URLs, email addresses can include domain names, enabling the same type of mapping to servers as described above for URLs.

Tax collectors may require for any entities within their jurisdictions to generate reports of select activities. Such activities may include, but are not limited to, purchases, sales, and other transactions in which financial instruments are being exchanged. Certain tokens may be considered financial instruments by tax collectors. For example, a tax collecting entity may indicate that any token that at some point has been determined to have a value exceeding $1000 is a financial instrument. When tokens considered financial instruments are traded without money being exchanged as part of the transaction, the trades may still comprise events required to be reported. Reports may be required of buyers and/or sellers when at least one of them is associated with a given jurisdiction. Tax authorities may determine, from reported transaction logs whether transactions are consistent with each other. Tax authorities may determine when there are apparent reporting gaps in logs, triggering more scrutiny to such events. Anomalous sales may be detected by tax authorities and induce further scrutiny. For example, a token previously valued at over $100,000 being sold for less than $1,000 may lead to additional scrutiny.

NFTs may carry some of their ownership information. Such ownership can also be stored in registries through entities including but not limited to by bounty hunters. Bounty hunters and associated methods were disclosed, for example, in co-pending applications U.S. Provisional Patent Application No. 63/238,890, titled “Methods for Ensuring Blockchain Integrity and Stability,” filed Aug. 31, 2021; U.S. Provisional Patent Application No. 63/229,924, titled “Integration of Real-World Data and Measurements into Distributed and Consensus-Based Environments,” filed Aug. 5, 2021; and U.S. patent application Ser. No. 17/808,264, titled “Systems and Methods for Token Creation and Management,” filed Jun. 22, 2022, the disclosures of which are incorporated by reference herein in their entirety. Under systems in accordance with various embodiments of the invention, inconsistency between transaction data reported by one of the parties to transactions, and data reported by bounty hunters may provide indications of potential abuse. When indications of potential abuse are found, reports of such can generate a reward for the disclosing bounty hunter(s). Reports of potential abuse may also generate potential penalties for the parties of the transactions, should there be reporting requirements for the transactions. An example of a reporting requirement may affect any NFT whose value exceeds a threshold value, when sold to a jurisdiction that requires reporting for purposes of sales tax. Reports of abuse may include payments of appropriate size (e.g., crypto payment). Reports may also include identifiers of the buyer and/or seller.

In accordance with a number of embodiments, tokens may include and/or reference data that indicates rules and policies regarding reporting. The rules and policies may include and/or reference one or more addresses of recipients. The referenced addresses may be customizable by entities including but not limited to token originators, token owners, token users, and authorities, such as local jurisdictions controlling what content is legal, tax authorities, and more. In the context of structure involving derived NFTs, rules and policies detailing reporting requirements and preferences may be contained in multiple NFTs. Derived tokens are disclosed in co-pending application as disclosed in U.S. patent application Ser. No. 17/808,264, titled “Systems and Methods for Token Creation and Management,” filed Jun. 22, 2022, the disclosure of which is incorporated by reference herein in its entirety.

In cases where NFTs reference rules and policies in public storage, the locations of the storage can be described by indicators of the ledger identities where the rules and policies are stored. Encoding of the rules and policies may be done in the form of executable elements. Rules and policies may also be in the form of data that is evaluated by executable elements. This data may include, but is not limited to parts of an NFT, parts of an execution environment, and/or a digital right management component running in a trusted execution environment.

As indicated above, reporting may be controlled by a plurality of sources, including but not limited to originators of content (such as artists) and mandates by authorities. For example, authorities in one jurisdiction may require that any content matching a given standard be marked when consumed and/or transported in that jurisdiction. Here, “consumed” may correspond to, but is not limited to, content being rendered, having content derived from it, and/or being resold. An example standard may be a statement such as, but not limited to, “likely to be political news” and “marked as being pornography.” The indication of whether content matches a category may be part of the container that includes the content. The indication may also be determined by DRMs rendering the content.

NFTs may include machine-readable descriptions that identify information including, but not limited to, what kind of data is reported, how it is aggregated, and/or how it is otherwise stripped of personally identifiable information (P11). Machine-readable descriptions may correspond to the data that is used to determine what information needs to be reported and how. Machine-readable descriptions may reference rules and policies specifying how an intermediary processing reports can protect end user privacy by removing P11. These rules and policies can be what governs the actions of the intermediaries. Machine-readable rules and policies may include, but are not limited to content that is used for promotional purposes.

Applications and/or execution environments may be set to only accept some types of information. For example, applications may be set to accept commonly used rules and policies. Systems in accordance with many embodiments may incorporate rules and policies that can be arranged on scales, such as one-dimensional and/or two-dimensional displays. In such systems users can specify areas corresponding to displays that correspond to acceptable rules and policies, configuring execution environments to only render qualifying content. For other types of content, content may be blocked. Alternatively or additionally, the user may be asked to agree to an exception, and potentially authenticate to have the exception accepted. This approach may imbue a given application with a series of standards. The standards may include, but are not limited to, limits on what type of content, according to some set of labels, that can be rendered on a given device and/or account.

Systems and techniques directed towards reporting transactions, in accordance with various embodiments of the invention, are not limited to use within NFT platforms. Accordingly, it should be appreciated that applications described herein can be implemented outside the context of an NFT platform network architecture and in contexts unrelated to the management of fungible tokens and/or NFTs. Moreover, any of the systems and methods described herein with reference to FIGS. 21-23 can be utilized within any of the NFT platforms described above.

D. Reporting Wallet Contents

Many embodiments of the invention can be applied to surveying digital wallets, communicating information on wallet contents to third parties. The use of such reporting mechanisms may be directed to, but are not limited to, determining facts related to wallets and/or facts related to the devices containing the wallets. Wallet and device information obtained may be applied to classifications of the interests of surveyed wallet users.

Systems and methods in accordance with various embodiments of the invention may be utilized for performing surveys of wallet contents and communicate results to relevant parties, based on privacy constraints associated with the wallets. The systems and methods can also be used to survey other boundaries. For example, surveys may be used with selected partitions of wallets, and/or sets of associated wallets. In accordance with several embodiments, surveys can be configured to be privacy protecting. Privacy protection may include but is not limited to measures that perform computing that complies with privacy settings of the associated survey areas, including both the privacy of the tokens, their associated assets such as metadata and data files, and privacy of the computing environment and its associated resources. Novel constructions may be used to protect the privacy of users, content creators and other parties by associating tokens with one or more policies governing the use of information associated with these tokens.

In accordance with several embodiments, survey functionality may be utilized through wallets and/or tokens. Wallets may have enabling functionality that read wallet contents and perform processing that has been enabled by user privacy settings. Survey functionality may also be performed by tokens themselves. Surveys performed by tokens may apply executable elements of the tokens. When activated, tokens with survey functionality may perform surveys and communicate results. In accordance with a number of embodiments survey-enabling elements in tokens and wallet functionality may be combined to support the surveying. Survey functionality may also be performed by cloud networked computer resources, as disclosed in U.S. patent application Ser. No. 17/811,831 titled “Systems and Methods for Token Management in Augmented and Virtual Environments,” filed Jul. 11, 2022, which is incorporated by reference in its entirety.

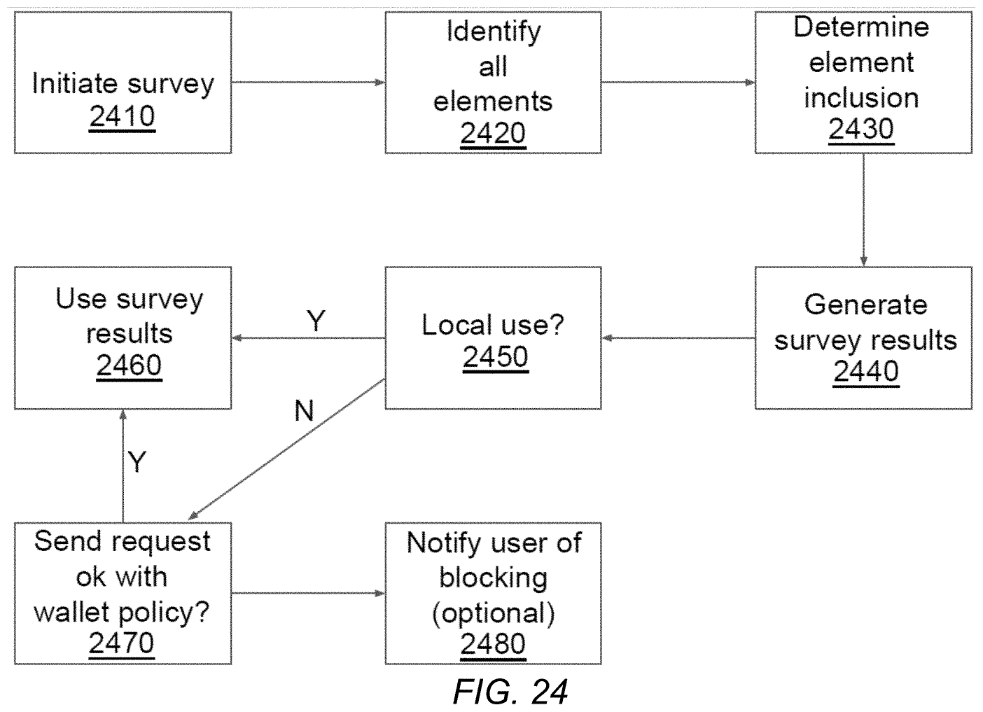

The processing flow for an example survey situation, in accordance with many embodiments of the invention, is illustrated in FIG. 24. Process 2400 initiates (2410) a survey. Surveys may be initiated (2410) through options including, but not limited to, via a token such as an NFT, by the wallet after interaction with a token, by the execution environment after interaction with a token, and/or by a user action (e.g., a user input on a user interface). Process 2400 identifies (2420) all elements that could be surveyed. Identification of elements may be based on, but are not limited to, instructions and configurations associated with the token initiating the survey. Process 2400 determines (2430) element inclusions for the survey.

Inclusion of elements in the survey may be based on, but are not limited to the elements that have been identified, policies associated with these elements, and policies that are associated with the wallet and/or execution environment. In accordance with a number of embodiments of the invention, wallet and/or execution environment policies may indicate what tokens can be included in the surveys. Element inclusion determination may also depend on a certification of an indicator associated with the token initiating the survey. For example a survey may be permitted if the certification specifies that it is allowed, and the certification was generated by a trusted authority. Indicator certifications may include, but are not limited to digital signatures of trusted authorities on data and/or code associated with the token and/or associated with data causing the initiation of the survey.

Process 2400 generates (2440) survey results based on the elements, e.g., tokens and other data, that have been included in the survey. Process 2400 determines (2450) whether the survey results that were computed are intended to be used locally. An example of locally used survey results may be results for the selection of an already received advertisement from a collection of such advertisements. When use is intended to be local, then process 2400 uses (2460) the survey results. For instance, survey results may be used to select what advertisement to render.

When use is not intended to be local, then process 2400 determines (2470) whether the transmission of a request is permissible. Requests may include, but are not limited to survey results and/or parts thereof. Determinations of whether transmission of requests are permissible may be based on a policy associated with the wallet and/or execution environment where the survey was performed. Determinations may also be based on the certificate described in step 2430. Wallet policies may be, but are not limited to user-selected privacy policies and policies set by an external authority (e.g. an employer of the user or a parent of the user). When use is not intended to be local, but transmission is permissible, process 2400 uses (2460) the survey results. When use is not intended to be local, but transmission is permissible, process 2400 optionally notifies (2480) wallet users that the transmission of the survey results were blocked. Survey results may be transmitted to entities including, but not limited to, users, service providers external authorities, and the creator of the token in question.

Based on the outcome of surveys, results can be communicated to various entities. Results may be communicated for a number of reasons, including but not limited to, requesting additional information of types relevant to the context of wallets and/or wallet users. Survey results can be used locally, and/or with associated devices. Survey results may be applied to select and/or guide actions. Examples of actions may include but are not limited to: identifying likely needs of users, including needs for information, needs for products, and needs for security; configuring user systems, including the wallets of users; and generating and presenting recommendations to users (e.g., based on the type/profile of user, and the preferences of similar users).

Communication performed in response to surveying may be performed between tokens in a wallet area being surveyed. For example, the communication may use APIs that may be controlled by the wallet(s). Intra-wallet communication may be applied to enable, for example, evolution between compatible tokens. The communication may also be between tokens and/or wallets and service providers associated with one or more of the tokens in the wallet. For example, service providers may be associated with tokens (such as NFTs) that include an element that triggers the performance of surveys.

Some tokens and/or wallets may include elements that determine properties of other tokens in shared wallets. For example, a first token may include an element, which, when activated, determines that the wallet the first token is stored in also stores a second token and a third token. The first token may related to the second token (e.g., both are badges related to having made good investments). The third token may be an NFT that includes an artwork. In accordance with some embodiments, tokens and/or wallets may be used to perform actions including but not limited to assessing demographics for tokens. The first token may generate a demographic characterization of the other tokens (i.e., of the second token and the third token) and perform actions that depend on demographic characterizations.

In accordance with several embodiments, tokens may bond with each other to facilitate communication. When two tokens are bonded, they may interact with each other and exchange information. Information exchanges may result in the modification of one or more of the bonded tokens (e.g., evolution). Token evolution is disclosed in co-pending applications in U.S. Provisional Patent Application No. 63/248,570 titled “Content Evolution Technique,” filed Sep. 27, 2021; and in U.S. Provisional Patent Application No. 63/254,062 titled “Token Evolution with Physical Embodiment,” filed Oct. 9, 2021, which are incorporated by reference in their entireties.

Information exchanges may also result in messages being sent to third parties (e.g., the issuer of one of the tokens). Message transmissions may depend on wallet configurations including but not limited to whether particular message transmissions are accepted by wallets. Message transmissions may also depend on user decisions. For example, a popup/other notification may request whether a message can be transmitted. Determinations of whether messages may be transmitted may depend on the nature of particular messages. For example, one user may have configured her wallet to allow any message transmissions that do not include personally identifiable information (PII). Another user may have configured his wallet to allow any message transmissions that only convey general demographic information such as the existence of a token of a given category. A third user may have configured her system to not allow any message transmissions at all. A fourth user may have configured her system only to allow message transmissions to parties she has identified as trusted. A fifth user may configure the system to always ask before sending a message transmission, unless they have indicated “always enable transmissions to this recipient” in response to a previous request.

For systems in accordance with several embodiments, the processing of the other tokens of the wallet may be based on a privacy configuration of the wallet. For example, users may indicate that a particular form of reporting is allowable, but not another. In such cases, processing can create an output that is in compliance with the privacy configuration and transmit the associated output from the computation. Thus, instead of blocking or allowing requests for data transmissions, the systems may tailor the transmissions to fit the privacy configurations.

In accordance with various embodiments, tokens may be associated policies governing the conditions of which their presence may be conveyed to external resources. For example, policies may limit messaging that relates to and/or references certain tokens. In such cases, tokens may still permit cumulative descriptions (e.g., an assessment that states that the wallet contains between 10 and 100 NFTs). Policies that limit the information conveyed about certain tokens may be referred to as a privacy policy associated with the token. Singular tokens may have multiple privacy policies. A first type of privacy policy may be associated with wallets, wallet partitions, wallet contents, and/or wallet content categories. The first type of policy may have been set by users associated with wallets. In accordance with several embodiments, policies may be external to, but associated with tokens. Policies that are external to tokens may be associated with the tokens and/or corresponding wallets in a database. A second type of privacy policy may be set by the content creators of tokens, and may be part of the tokens. A third type of privacy policy may be set by a jurisdiction. Jurisdictions may include but are not limited to states, countries, organizations, and businesses. The third type of privacy policy may apply to all content of a given type associated with the entity that set it. For example, a privacy policy may apply to all residents of a country, all employees of a company, etc. Some tokens may have more than one privacy policy associated with them. In cases, where multiple overlapping privacy policies exist, the most restrictive policy may control the use of information, whether such use may be the communication of information and/or the use inside particular wallet (e.g., for purposes of evolution).

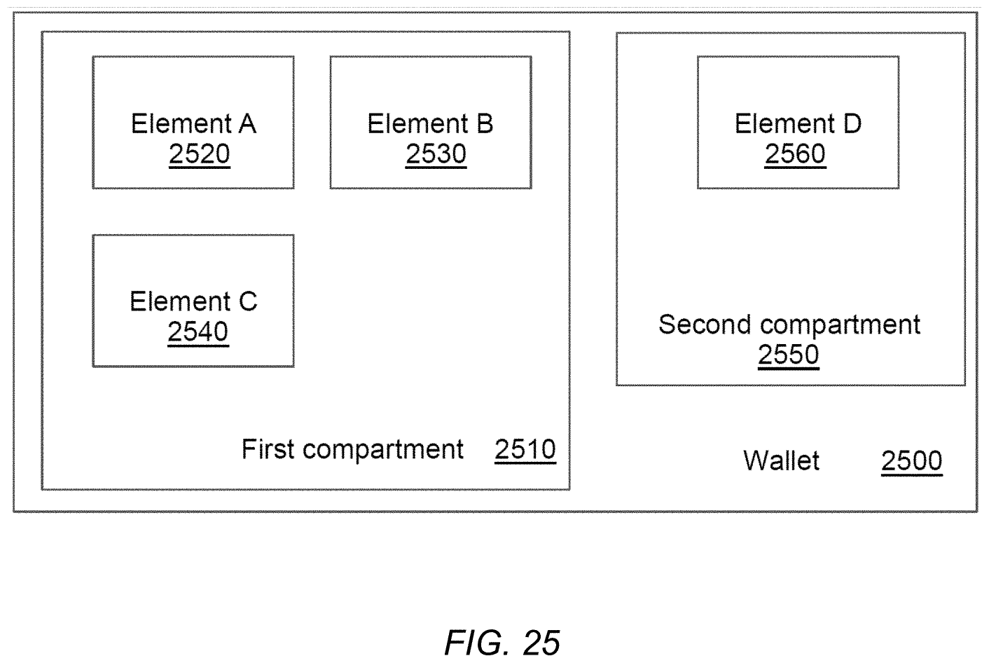

A wallet configured to enable surveys, in accordance with some embodiments of the invention, is illustrated in FIG. 25. Wallets 2500 may include a first compartment 2510 and a second compartment 2550. Tokens, such as element A 2520, can initiate surveys. Wallets 2500 may be configured only to show contents of one compartment to elements in the same compartment. For content in one compartment, knowledge of external compartments may be ignored altogether. For example, for content in the first compartment 2510, access may be limited to elements in first compartment 2510. In such a case, the survey initiated by element A 2520 may not be able to detect any elements of second compartment 2550. The survey may not even detect the fact that there exists a second compartment 2550.

In accordance FIG. 25, the survey may determines (e.g., using step 2420), that element A 2520, element B 2530 and element C 2540 are all identified elements. Element D 2560 may not be identified. The token/element that initiates a survey may be excluded from the survey based on the type of survey. As such, the survey may alternatively include the creating element. When a survey is initiated by element A 2520, element A 2520 may be excluded from the survey, based on the design of the survey. Certain elements may have policies to block or allow surveys. Element B 2530 may have a policy associated with it that blocks it from being surveyed. Element C 2540 may have a policy associated with it that allows it to be surveyed.

The use of surveys can support ad-based services, wherein a service provider offers tokens for free. Offered tokens may, for example, provide certain privileges and/or benefits (e.g., providing access to a movie). Tokens may include survey components and/or be associated with other tokens with survey components that, when activated, determine various information. The information may include, but is not limited to, facts related to wallets, facts related to the devices containing the wallets, and/or the environment of the wallet owners. These surveys may result in classifications of user interests, which can be used to select future advertisements. In the earlier examples, the advertisements may be automatically downloaded with the movie and/or downloaded on demand.

In accordance with a number of embodiments, surveys may aim at identifying the average value of surveyed elements, excluding the element that initiated the survey, and excluding elements whose policies block their inclusion in the survey. Element C 2540 may have a value estimated to be 0.04 BTC (four hundredths of a bitcoin). The result of the survey may therefore be 0.04 BTC since Elements A 2520, B 2530, and D 2560 are excluded. Identifying the average value of surveyed elements may be used to select advertisements. For instance, an advertisement may be selected from a collection of three advertisements, where the first advertisement is rendered when there are no elements included in a survey, the second when the result of the survey is less than or equal to 0.5 BTC, and/or the third if the result of the survey is greater than 0.5 BTC. In the above example, the 0.04 BTC may induce the second advertisement to be displayed.

Advertisements associated with surveys may be applied in various situations (e.g., in the movie, before, and/or in a separate situation). After selected advertisements are rendered, user actions may be observed and/or collected. In response to the associated data, messages can be sent to service providers, Such messages may, for instance, be automated requests for more information. When advertisement-carrying tokens perform surveys but do not convey results external entity, the token may circumvent the privacy policies of tokens stored. This may be a desirable alternative to the intrusive nature of targeted advertisements, and allow for careful selection of ad content based on activities indicated by wallet contents. Techniques for token-based advertising and promotion are disclosed in co-pending application U.S. patent application Ser. No. 17/811,831 titled “Systems and Methods for Token Management in Augmented and Virtual Environments,” filed Jul. 11, 2022, which is incorporated by reference in its entirety. In accordance with various embodiments, these advertising techniques can also be implemented alongside advertisement-carrying tokens.

In accordance with many embodiments, surveys can be initiated and/or performed by a variety of components. Survey initiating entities may include but are not limited to tokens (e.g., NFTs), wallets, applications, and/or execution environments used to process (e.g., display and use) tokens and/or crypto currency. Surveys can be performed on tokens associated with users, funds associated with users, event history associated with users and/or wallets, social media accounts, websites bookmarked, etc.

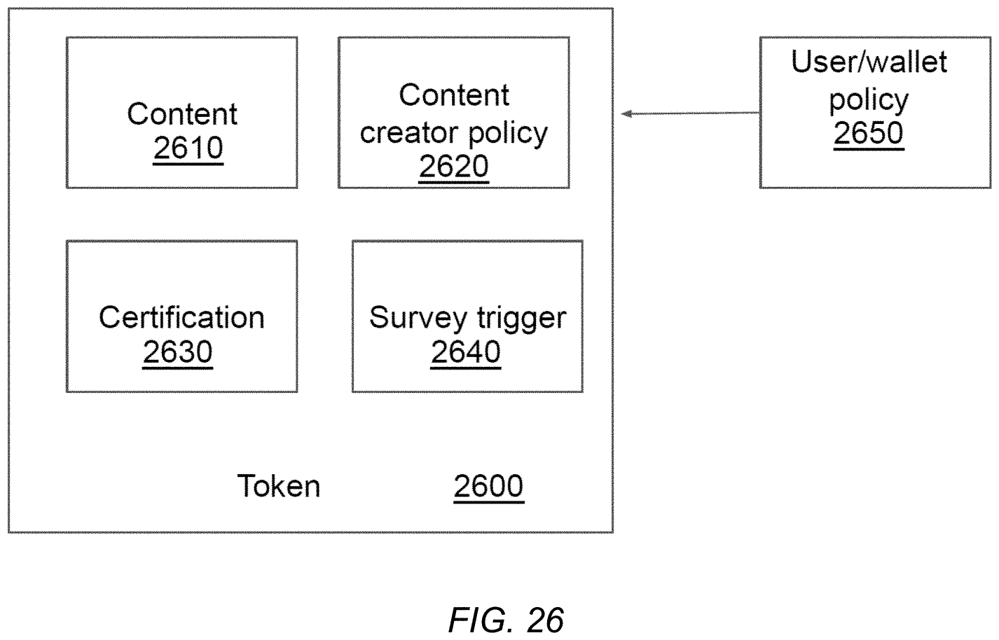

A configuration wherein a token incorporates survey functionality, in accordance with several embodiments of the invention, is illustrated in FIG. 26. FIG. Tokens 2600 may include, but are not limited to, content 2610, content creator policies 2620, certificates 2630, and survey triggers 2640. Content may include, but is not limited to artwork. Content creator policies 2620 may specify the conditions under which tokens 2600 can be surveyed. For example, a token 2600 corresponds to element B then the content creator policies 2620 may specify that it cannot be surveyed. In this example, content creator policies 2620 may state that the token 2600 may be surveyed. Survey triggers 2640 may include instructions for surveys. Certificates 2630 may correspond to assurances, by trusted authorities, that survey triggers meet a particular threshold. The thresholds may be specified by wallets and/or execution environments. Privacy may be measured through a privacy score. For example, a privacy score may be on a scale of 0-10, wherein a privacy score of 5 is required for a certificate. User/wallet policies 2650 may specify additional requirements for the survey. For instance, user/wallet policies 2650 may state that a token 2600 may be surveyed only by another token from the same creator. The certificate 2630 may be used to determine whether the survey can be initiated. When the survey is not permissible, it may not be initiated. For example, it may be determined that, since the certification 2630 of the token 2600 specifies that the token 2600 has a privacy score of 4.3 on a scale between 0 and 10, under a wallet-specified threshold of 5.0, the survey request made by the token 2600 may not be permissible. When the survey is permissible then the survey can be initiated.

In accordance with various embodiments, privacy policies can be set to prevent aspects of surveying. For example, users may configure their wallets and/or trusted execution environments to block any reporting of presence of crypto funds to external entities. Additionally or alternatively, users may configure their wallets and/or trusted execution environments to allow the selection of advertisements based on survey results influenced by the presence of funds and/or the amount of such funds. Users may also configure their wallets and/or trusted execution environments to have policies including, but not limited to only allowing surveys to be performed on NFT material; conveying survey results to a pre-determined list of trusted entities, allowing any survey to be reported; using anonymizers as intermediaries. In accordance with several embodiments, anonymizers may block personally identifiable information (PII) from being reported. Additionally or alternatively, traffic anonymization may prevent the recipients of survey results from knowing the IP addresses and/or identifiers of wallets and/or execution environments of senders. Mix networks (such as Tor) can be used as anonymizers, as well as other mix network constructions. Systems and methods in accordance with some embodiments can also use anonymization approaches such as described in Michael K. Reiter and Aviel D. Rubin, “Anonymity Loves Company: Anonymous Web Transactions with Crowds,” Communications of the ACM (February, 1999), which is incorporated by reference in its entirety.

In accordance with a number of embodiments anonymizers may have policies identifying information including but not limited to, what types of survey results to allow, which ones to block, and which ones to modify, and how to modify them. Anonymizers may further have a blocklist of entities to which survey results should not be sent. These lists may correspond to categories that associated users have selected, including but not limited to malicious, pesky, advertisers, scammers, spammers, etc. Anonymizers and/or an associated parties may maintain lists of entities corresponding to disallowed categories. Anonymizers may also have whitelists corresponding to what traffic to permit. In accordance with many embodiments, anonymizers may include one or more network nodes, where the execution environment of the wallet may correspond to one such node, and one or more additional nodes may be part of a network of intermediaries. Intermediaries may also be used to request advertisements and/or other data without giving away which execution environments initiated the advertisement requests.

In accordance with some embodiments, surveys may be triggered (e.g., by a token being evaluated and/or rendered) while the results of surveys are stored. Surveys may be triggered by a variety of sources, including but not limited to smartphone token wallets knowledgeable of tokens' policies (such as actions associated with location triggers and smartphone geolocation). Storing the results of surveys may facilitate the generation of other surveys onwards. In particular, many surveys may request the same facts, and the same determination may not have to be performed each time. Surveys may include a collection of results, each one of which corresponds to specific queries. These queries, their associated results, and time stamps associated with the time of determination can be stored by wallets, anonymizers, and/or other entities associated with the generation of survey results. When state changes in environments takes place, some stored survey results may be invalidated whereas others may remain cached. Some survey results may expire after some amount of time (e.g., two days). After expiration, survey results may have to be recomputed for new surveys.

Before surveys are performed, stored results can be accessed to determine whether at least some of survey results are already known. For systems acting in accordance with numerous embodiments, accessing stored results so can reduce the computational burden and avoid repeated determinations of whether given results are acceptable to be shared. Cached results may also indicate (and/or help determine) the parties allowed to receive subsequent results. The storage of survey results can be desirable on power-constrained devices, such as phones, in order to reduce the consumption of power. In accordance with some instances, computationally demanding surveys may not be computed on power-constrained devices. Instead they may be computed on associated computers, such as laptops associated with the same owner, while the results are exported and stored until expiring and/or erased. When power-constrained devices are requested to generate surveys without the power resources to do so, and/or without the results being stored, then the devices may also use partial results.

Systems and techniques directed towards surveying digital wallets, in accordance with various embodiments of the invention, are not limited to use within NFT platforms. Accordingly, it should be appreciated that applications described herein can be implemented outside the context of an NFT platform network architecture and in contexts unrelated to the management of fungible tokens and/or NFTs. Moreover, any of the systems and methods described herein with reference to FIGS. 23-26 can be utilized within any of the NFT platforms described above.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method directed to tracking digital wallet transactions comprising:
generating an anchor token;
associating the anchor token with one or more digital wallets;
deriving a reference corresponding to the anchor token; and
encrypting the reference to produce a ciphertext;
wherein the ciphertext is encrypted using a public key associated with a designated entity.

2. The method of claim 1, wherein the anchor token further comprises an identifier unique to an owner of at least one digital wallet that is selected from the group consisting of a name, a pseudonym, date of birth, social security number, contact information, a jurisdiction the owner belongs to, and a usage profile of the owner's.

3. The method of claim 1, wherein the reference comprises at least one of:
an indicator pointing to a database entry identifying an owner of at least one digital wallet; and
an identifier token disclosing personal information about the owner.

4. The method of claim 1, wherein the reference further comprises information for unlocking at least one digital wallet that is selected from the group consisting of a biometric template of an owner of at least one digital wallet and a salted-and-hashed password.

5. The method of claim 1, wherein the reference further comprises a record of all transactions performed by at least one digital wallet.

6. The method of claim 1, wherein the reference is encrypted using EIGamal-based encryption.

7. The method of claim 1, wherein usage profiles enable sharing among the one or more digital wallets, wherein sharing includes at least one of preferences, usage history, purchase history, and references to digital wallet contents.

8. The method of claim 1, wherein the ciphertext is decrypted by a private key corresponding to the public key associated with the designated entity.

9. The method of claim 1, wherein a private key corresponding to the public key associated with the designated entity is distributively held through a polynomial threshold sharing method comprising multiple members of the designated entity.

10. The method of claim 1, wherein a privacy policy determined by an owner of at least one digital wallet governs use of the ciphertext by third party entities.

11. The method of claim 1, wherein a pairing comprising the public key of at least one digital wallet and the reference are stored in a public database.

12. A machine-readable medium containing bytecode stored within an immutable ledger, where the bytecode encodes an anchor token comprising a tracker comprising a ciphertext;
wherein the ciphertext is an encrypted reference that confirms association with at least one digital wallet; and
wherein the ciphertext is encrypted using a public key associated with a designated entity.

13. The machine-readable medium of claim 12, wherein the anchor token further comprises an identifier unique to an owner of the at least one digital wallet that is selected from the group consisting of a name, a pseudonym, date of birth, social security number, contact information, a jurisdiction the owner belongs to, and a usage profile of the owner's.

14. The machine-readable medium of claim 12, wherein the anchor token further comprises information for unlocking a digital wallet that is selected from the group consisting of a biometric template of an owner of the digital wallet and a salted-and-hashed password.

15. The machine-readable medium of claim 12, wherein the anchor token corresponds to multiple digital wallets.

16. The machine-readable medium of claim 12, wherein the tracker is encrypted using EIGamal-based encryption and further comprises a record of all transactions performed by the at least one digital wallet.

17. The machine-readable medium of claim 13, wherein usage profiles enable sharing among two or more digital wallets, wherein sharing includes at least one of preferences, usage history, purchase history, and references to contents of the two or more digital wallets.

18. The machine-readable medium of claim 12, wherein the ciphertext is decrypted by a private key corresponding to the public key associated with the designated entity.

19. The machine-readable medium of claim 15, wherein a private key, corresponding to the public key associated with the designated entity, is distributively held through a polynomial threshold sharing machine-readable medium comprising multiple members of the designated entity.

20. The machine-readable medium of claim 12, wherein a privacy policy determined by an owner of at least one digital wallets governs use of trackers by third party entities.
